(19) United States
(12) Patent Application Publication
(10) Pub. No.: US 2009/0083127 A1
(43) Pub. Date: Mar. 26, 2009

(54) ANALYSIS APPARATUS, PROGRAM AND ANALYSIS METHOD

(76) Inventors: Hiroyuki Konno, Yokohama (JP); Kenichi Funaki, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/178,801

(22) Filed: Jul. 24, 2008

(30) Foreign Application Priority Data
Sep. 25, 2007 (JP) 2007-247381

(51) Int. Cl. G06F 17/30

(52) U.S. Cl. 705/10

(57) ABSTRACT

An analysis apparatus includes a needs relation definition unit to receive input of relation among needs for a product, worth to satisfy the needs and values of selection items for selecting the worth through an input unit and a needs estimation unit to prepare a questionnaire which receives selection of selection order for combination of inputted needs and selection of values for judging to be satisfactory and dissatisfactory for inputted worth and calculate strength of the needs from totalized result of the questionnaire.

### INCORPORATION BY REFERENCE

The present application claims priority from Japanese application JP 2007-247381 filed on Sep. 25, 2007, the content of which is hereby incorporated by reference into this application.

### BACKGROUND OF THE INVENTION

The present invention relates to technique of developing a product responsive to customers' needs.

When a products is developed, it is desired to provide the product that is more acceptable in the market.

As disclosed in JP-A-2004-110432, for example, as the conventional technique for supporting development of product responsive to the needs, there is known the technique that a questionnaire is used to get the customers' needs and the target performance for functions of the product is decided responsive to the gotten needs.

### SUMMARY OF THE INVENTION

In the conventional technique, when the performance of the product functions responsive to the customers' needs is studied, some plans are described as items of a questionnaire and an effective performance plan is decided from the result of the questionnaire.

However, unless the correspondence relation of the needs and the product functions is set correctly, the customers' needs cannot be satisfied.

Accordingly, it is an object of the present invention to provide the technique capable of developing a product correctly responsive to customers' needs by making the customers' needs correspond to the product functions.

In order to solve the above problem, according to the present invention, a questionnaire is prepared on the basis of the needs for a product and worth to satisfy the needs and the strength of the needs is calculated from the result of the questionnaire.

According to the present invention, an analysis apparatus comprises a needs relation definition unit to receive input of relation among needs for a product, worth to satisfy the needs and values of selection items for selecting the worth through an input unit and a needs estimation unit to prepare a questionnaire which receives selection of selection order for combination of inputted needs and selection of values for judging to be satisfactory and dissatisfactory for inputted worth and calculate strength of the needs from totalized result of the questionnaire.

According to the present invention, the product responsive to the customers' needs can be developed on the basis of the correspondence of the customers' needs, the strength of the customers' needs and the functions of the product.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating an analysis apparatus 100 according to an embodiment of the present invention;

FIG. 2 is a block diagram schematically illustrating a computer 180;

FIG. 3 is a sequence diagram showing processing of the analysis apparatus 100 shown in FIG. 1;

FIG. 4 is a schematic diagram illustrating a needs input picture 160;

FIG. 5 is a schematic diagram illustrating a needs node setting picture 161;

FIG. 6 is a schematic diagram illustrating a link setting picture 162;

FIG. 7 is a diagram showing a strength-of-relation selection table 163;

FIG. 8 is a schematic diagram illustrating a worth class node setting picture 164;

FIG. 9 is a diagram showing a sign-of-equality-and-inequality selection table 165;

FIG. 10 is a diagram illustrating an image displayed when information is inputted by means of nodes and links;

FIG. 11 is a schematic diagram illustrating a registration picture 166;

FIG. 12 is a diagram showing a node table 121a;

FIG. 13 is a diagram showing a needs link table 122a;

FIG. 14 is a diagram showing a specification plan table 123a;

FIG. 15 is a schematic diagram illustrating a data read-in picture 167;

FIG. 16 is a schematic diagram illustrating a needs-related questionnaire 167;

FIG. 17 is a flowchart showing processing of preparing the needs-related questionnaire;

FIG. 18 is a diagram showing an orthogonal array of L8;

FIG. 19 is a diagram showing a node name table 125a;

FIG. 20 is a diagram showing a profile table 126a;

FIG. 21 is a diagram showing a needs pattern selection table 127a;

FIG. 22 is a diagram showing a selection degree table 168;

FIGS. 23A and 23B are diagrams showing satisfactory degree distribution and dissatisfactory degree distribution;

FIG. 24 is a schematic diagram illustrating a needs node setting picture 161;

FIG. 25 is a schematic diagram illustrating a needs input picture 160;

FIG. 26 is a schematic diagram illustrating an element class node setting picture 169;

FIG. 27 is a schematic diagram illustrating a worth class selection picture 170;

FIG. 28 is a schematic diagram illustrating a campus area 160b;

FIG. 29 is a diagram showing an element link table 128a;

FIG. 30 is a schematic diagram illustrating a worth-related questionnaire 171;

FIG. 31 is a flowchart showing processing of preparing the worth-related questionnaire 171;

FIG. 32 is a schematic diagram illustrating a price mode setting picture 172;

FIG. 33 is a diagram showing a price-related questionnaire profile table 130a;

FIG. 34 is a diagram showing an element pattern selection table 131a;

FIG. 35 is a diagram showing a quantity table 132a;

FIG. 36 is a flowchart showing target cost calculation processing;

FIG. 37 is a schematic diagram showing the relation of price plans and quantity; and

FIG. 38 is a schematic diagram illustrating a display example of target costs.

### DESCRIPTION OF THE EMBODIMENTS

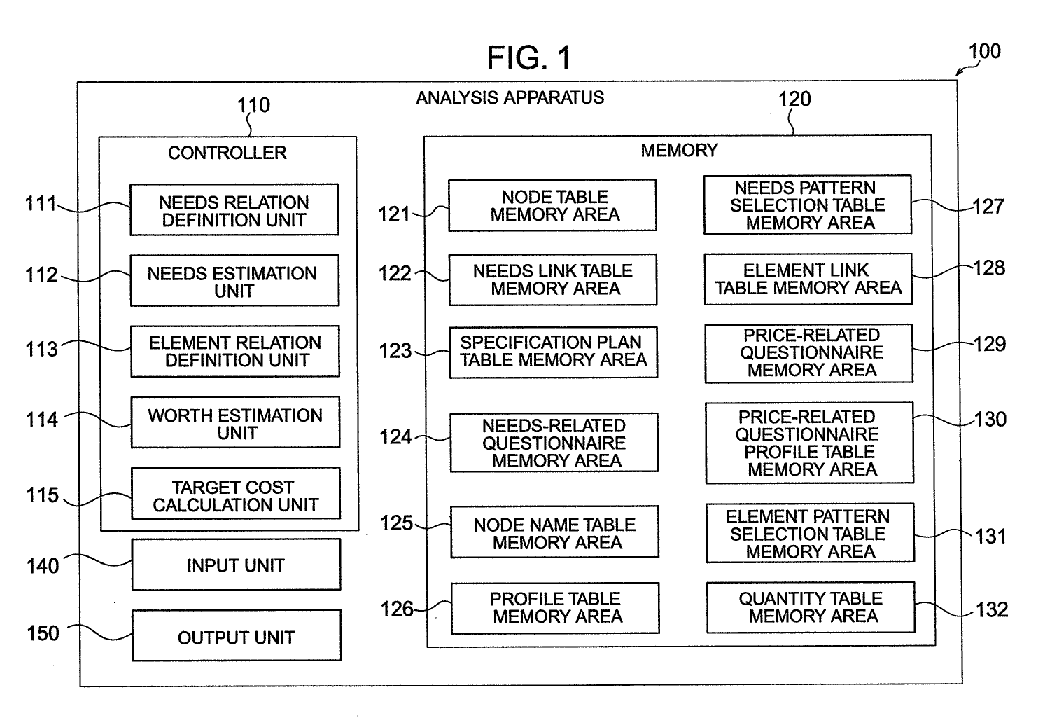

FIG. 1 is a schematic diagram illustrating an analysis apparatus 100 according to an embodiment of the present invention.

As shown in FIG. 1, the analysis apparatus 100 includes a controller 110, a memory 120, an input unit 140 and an output unit 150.

The controller 110 includes a needs relation definition unit 111, a needs estimation unit 112, an element relation definition unit 113, a worth estimation unit 114 and a target cost calculation unit 115.

The needs relation definition unit 111 receives input of information for specifying the needs for a product, the causal relationship among the needs, worth of the needs, the relation between the needs and the worth and the strength of the relation from an operator of the analysis apparatus 100 and stores the information in the memory 120.

The needs estimation unit 112 prepares a needs-related questionnaire on the needs for the product on the basis of the information stored in the memory 120 and estimates the needs for the product on the basis of reply result submitted to the prepared questionnaire.

The element relation definition unit 113 receives input of information for specifying elements constituting the product, worth of the elements and the relation between the elements and the worth and stores the information in the memory 120.

The worth estimation unit 114 prepares a price-related questionnaire on worth related to elements of the product and price related to the worth on the basis of the information stored in the memory 120 and estimates the needs for the product on the basis of reply result submitted to the prepared price-related questionnaire.

The target cost calculation unit 115 calculates a target price and a target cost of the product on the basis of the estimation results of the needs estimation unit 112 and the worth estimation unit 114.

The memory 120 includes a node table memory area 121, a needs link table memory area 122, a specification plan table memory area 123, a needs-related questionnaire memory area 124, a node name table memory area 125, a profile table memory area 126, a needs pattern selection table memory area 127, an element link table memory area 128, a price-related questionnaire memory area 129, a price-related questionnaire profile table memory area 130, an element pattern selection table memory area 131 and a quantity table memory area 132.

The node table memory area 121 stores information for specifying nodes inputted to specify the needs, the worth and the elements constituting the product.

The information stored in the memory area is described later in detail.

The needs link table memory area 122 stores information for specifying the relation among the nodes inputted to specify the needs and the worth.

The information stored in the memory area is described later in detail.

The specification plan table memory area 123 stores information for specifying the worth of the needs.

The information stored in the memory area is described later in detail.

The needs-related questionnaire memory area 124 stores information for specifying the needs-related questionnaire prepared by the needs estimation unit 112.

The information stored in the memory area is described later in detail.

The node name table memory area 125 stores information for specifying assignment of the nodes in the needs-related questionnaire.

The information stored in the memory area is described later in detail.

The profile table memory area 126 stores information for specifying profiles of answerers to the needs-related questionnaire.

The information stored in the memory area is described later in detail.

The needs pattern selection table memory area 127 stores information for specifying needs patterns that answerers select “desired” or “undesired” in the needs-related questionnaire.

The information stored in the memory area is described later in detail.

The element link table memory area 128 stores information for specifying the relation among the nodes inputted to specify the elements constituting the product.

The information stored in the memory area is described later in detail.

The price-related questionnaire memory area 129 stores information for specifying the price-related questionnaire prepared by the price estimation unit 114.

The information stored in the memory area is described later in detail.

The price-related questionnaire profile table memory area 130 stores information inputted to a profile part of the price-related questionnaire described later.

The information stored in the memory area is described later in detail.

The element pattern selection table memory area 131 stores information inputted to a pattern selection part of the price-related questionnaire 171 and information calculated from the information inputted in the pattern selection part.

The information stored in the memory area is described later in detail.

The quantity table memory area 132 stores information for specifying the quantity calculated by the price estimation unit 114.

The information stored in the memory area is described later in detail.

The input unit 140 receives information from the operator of the analysis apparatus 100.

The output unit 150 outputs information to the operator of the analysis apparatus 100.

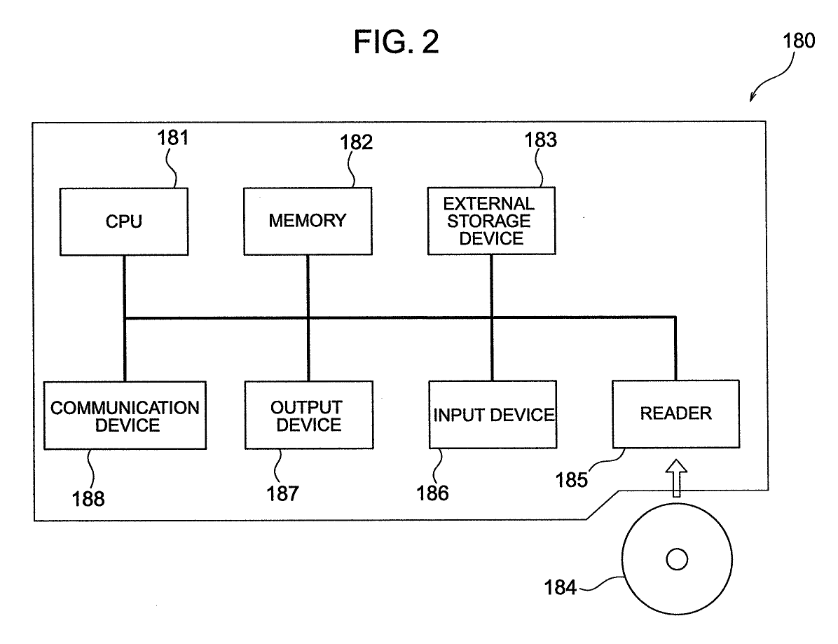

The analysis apparatus 100 described above can be realized by a general computer 180, as shown in FIG. 2, including a central processing unit (CPU) 181, a memory 182, an external storage device 183 such as a hard disk drive (HDD), a reader 185 for reading out information from a portable storage medium 184 such as a CD-ROM (compact disk read only memory) and a DVD-ROM (digital versatile disk read only memory), an input device 186 such as a keyboard and a mouse, an output device 187 such as a display and a communication device 188 such as a network interface card (NIC) for connection with a communication network.

For example, the memory 120 can be realized by making the CPU 181 utilize the memory 182 or the external storage device 183, the controller 110 can be realized by loading a predetermined program stored in the external storage device 183 into the memory 182 and executing it by the CPU 181, the input unit 140 can be realized by making the CPU 181 utilize the input device 186, and the output unit 150 can be realized by making the CPU 181 utilize the output device 187.

The predetermined program may be downloaded from the storage medium 184 through the reader 185 or from the network through the communication device 188 into the external storage device 183 and then be loaded into the memory 182 to be executed by the CPU 181. Alternatively, the predetermined program may be loaded from the storage medium 184 through the reader 185 or from the network through the communication device 188 into the memory 182 directly to be executed by the CPU 181.

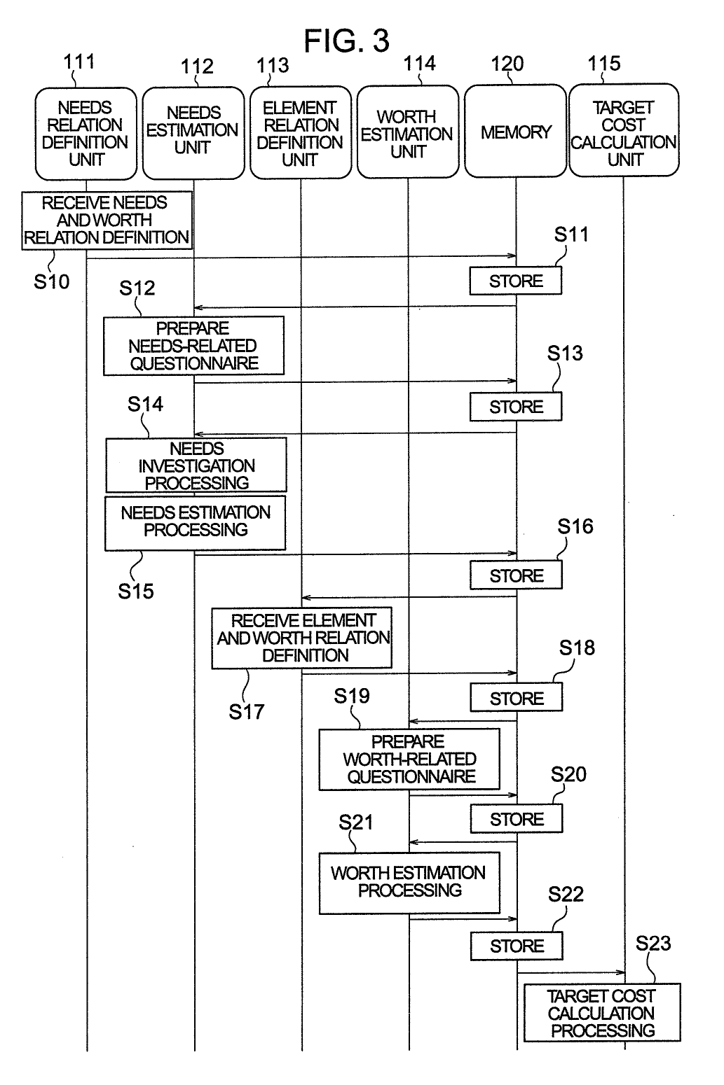

FIG. 3 is a sequence diagram showing processing of the analysis apparatus 100.

The needs relation definition unit 111 of the controller 110 receives input of information for specifying the needs relative to the product, the causal relationship of the needs, the worth such as functions and properties of the product related to the needs, the relation between the needs and the worth and the strength of the relation through the input unit 140 and the output unit 150 by means of nodes and links (step S10).

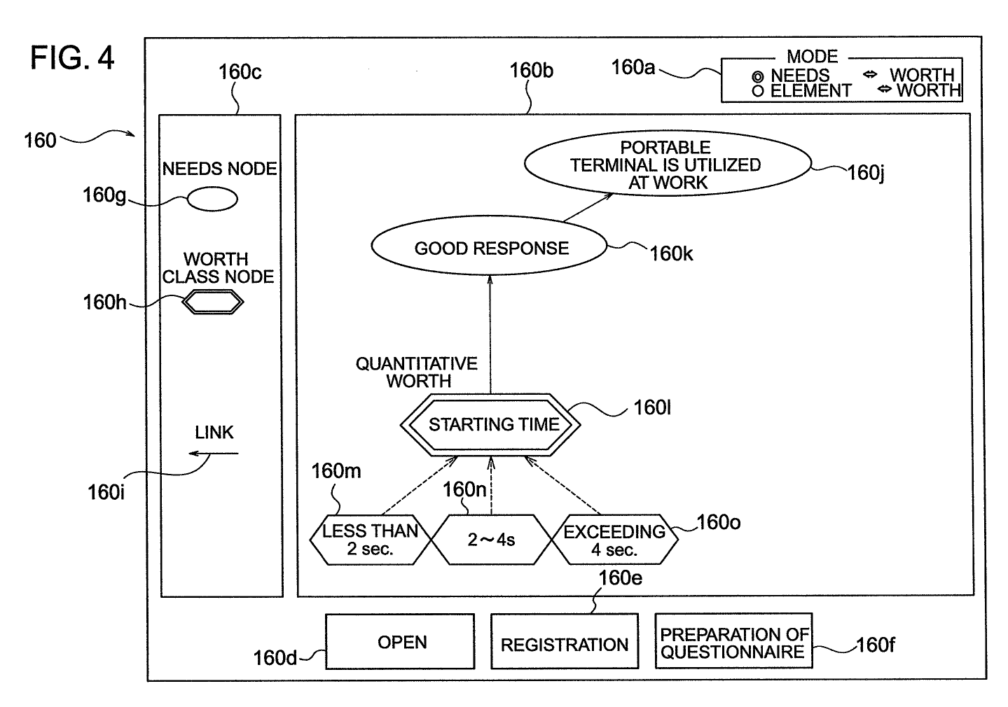

For example, the needs relation definition unit 111 displays a needs input picture 160 as shown in FIG. 4 onto the output unit 150 and receives input of necessary information through the input unit 140.

The needs input picture 160 includes a mode selection area 160a, a campus area 160b, a palette area 160c, an open button display area 160d, a registration button display area 160e and a questionnaire preparation button display area 160f.

First, the operator of the analysis apparatus 100 selects which of information relative to the needs or the element is inputted in the mode selection area 160a by means of the input unit 140. Here, it is supposed that the information relative to the needs is inputted.

When it is selected that the information relative to the needs is inputted in the mode selection area 160a, a needs node object 160g, a worth class node object 160h and a link object 160i are displayed in the palette area 160c.

The operator of the analysis apparatus 100 drags and drops the objects displayed in the palette area 160c onto the campus area 160b by means of the input unit 140 so as to input the causal relationship of the needs and the worth.

For example, when it is supposed that the operator of the analysis apparatus 100 develops a product of a portable terminal and there are the needs to the effect that “portable terminal is utilized at work”, the operator drags and drops the needs node object 160g in the palette area 160c onto the campus area 160b by means of the input unit 140.

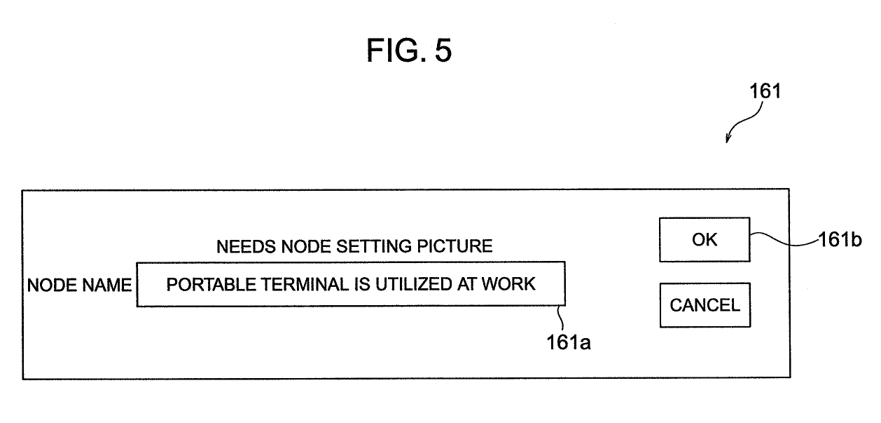

As a result, the needs relation definition unit 111 displays a needs node setting picture 161 as shown in FIG. 5 onto the output unit 150.

The operator of the analysis apparatus 100 inputs “portable terminal is utilized at work” as a name of a needs node into a needs node name input area 161a of the needs node setting picture 161 by means of the input unit 140 and selects an OK button display area 161b to input an execution instruction.

The needs relation definition unit 111 which has received such an input displays a needs node 160j having the name of “portable terminal is utilized at work” into the campus area 160b.

Further, the operator of the analysis apparatus 100 selects the link object 160i in the palette area 160c by means of the input unit 140 when the causal relationship (relationship between parent and child) is set between the nodes and then selects the needs nodes of cause and effect in the campus area 160b.

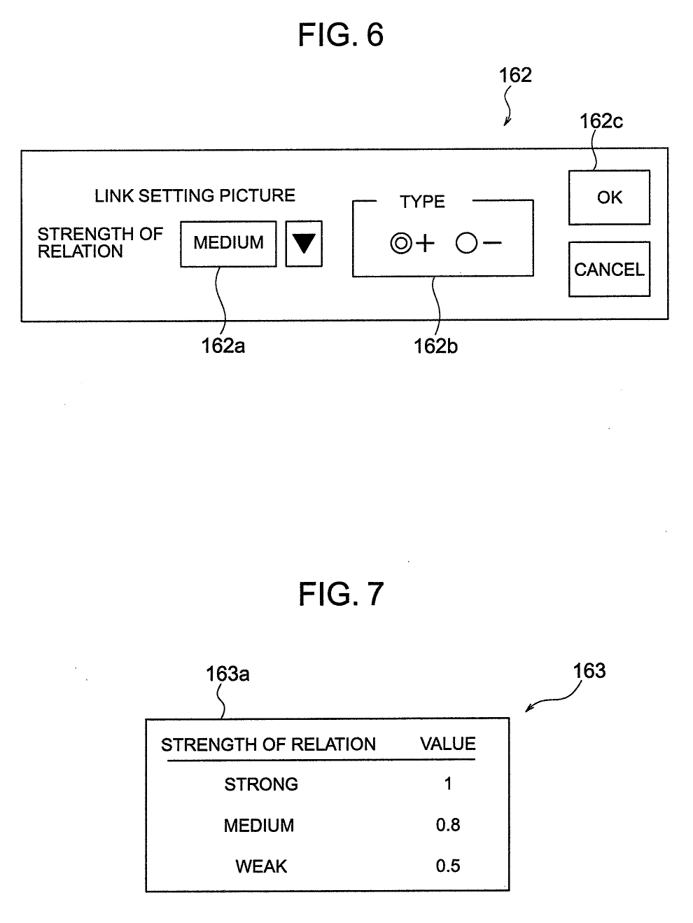

For example, when the causal relationship from the needs node 160k to the needs node 160j displayed in the campus area 160b is inputted, the operator of the analysis apparatus 100 selects the link object 160i in the palette area 160c by means of the input unit 140 and then selects the needs node 160k displayed in the campus area 160b. Thereafter, when the operator selects the needs node 160j, the needs relation definition unit 111 displays a link setting picture 162 as shown in FIG. 6 onto the output unit 150.

The operator of the analysis apparatus 100 inputs necessary information into a strength-of-relation input area 162a and a type input area 162b of the link setting picture 162 by means of the input unit 140.

In the embodiment, an input to the strength-of-relation input area 162a can be selected from information (“strong”, “medium” and “week” in the embodiment) stored in a strength-of-relation field 163a of a strength-of-relation selection table 163 as shown in FIG. 7 in a pull-down manner. The operator of the analysis apparatus 100 selects “strong”, “medium” and “weak” of the relation in accordance with the strength of the relation.

Moreover, “+” or “−” can be selected in the type input area 162b. When the needs represented by the needs node of cause is satisfied to thereby increase the utility of the needs represented by the needs node of effect in the causal relationship, “+” is selected and when the needs represented by the needs node of cause is satisfied to thereby reduce the utility of the needs represented by the needs node of effect, “−” is selected.

After the operator of the analysis apparatus 100 inputs the necessary information, the operator selects an OK input area 162c in the link setting picture 162 to input an execution instruction by means of the input unit 140, so that the needs relation definition unit 111 displays an arrow starting from the needs node 160k selected first and ending in the needs node 160j selected next onto the campus area 160b to thereby display the causal relationship therebetween. For example, the thickness of the arrow can be changed to display the strength of the relation and “−” can be displayed in a position adjacent to the arrow to display that there is a negative correlation therebetween.

When the operator of the analysis apparatus 100 sets a worth item such as function and property of the product related to the needs, the operator drags and drops the worth class node object 160h displayed in the palette area 160c onto the campus area 160b by means of the input unit 140.

For example, when the operator of the analysis apparatus 100 sets “starting time” as a worth item of the product for realizing the portable terminal having a good response, the operator first drags and drops the worth class node object 160h onto the campus area 160b by means of the input unit 140.

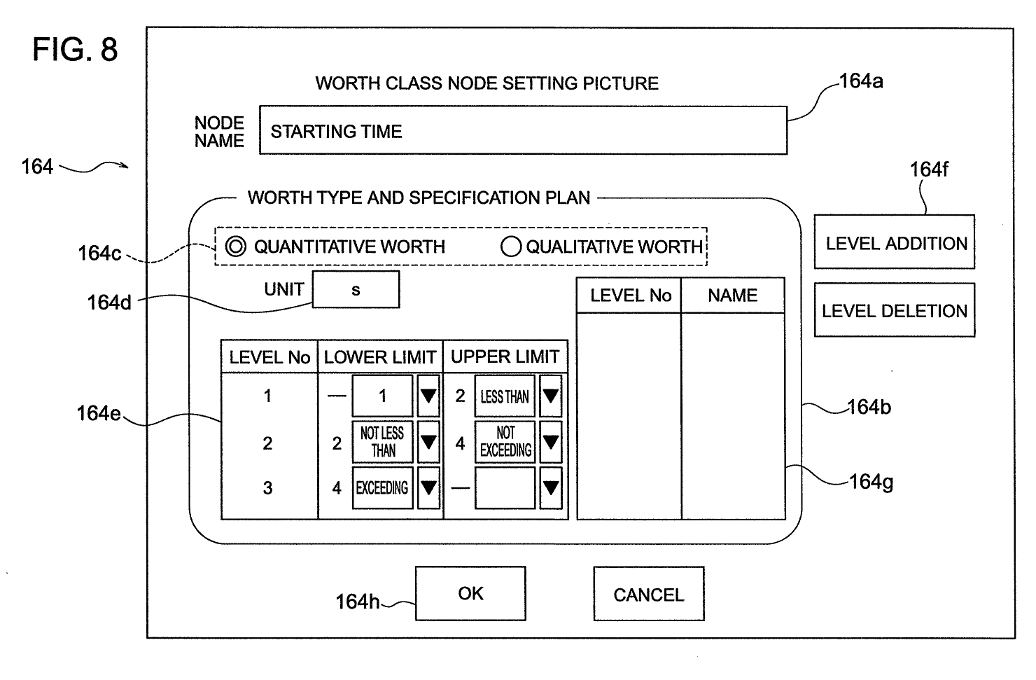

As a result, the needs relation definition unit 111 displays a worth class node setting picture 164 as shown in FIG. 8 onto the output unit 150.

The operator of the analysis apparatus 100 inputs necessary information to a node name input area 164a and a worth type and specification plan input area 164b by means of the input unit 140.

First, the operator of the analysis apparatus 100 inputs a string of characters for specifying a name of worth item to the node name input area 164a by means of the input unit 140.

Next, the operator of the analysis apparatus 100 selects in a worth selection area 164c whether the worth item specified in the node name input area 164a is the quantitative worth (e.g. time, weight, etc.) that can be measured quantitatively or the qualitative worth (e.g. design etc.) that cannot be measured quantitatively in the worth type and specification plan input area 164b by means of the input unit 140.

When the operator of the analysis apparatus 100 selects the quantitative worth, input of unit for the quantitative worth is received in a unit input area 164d and input of level of selection items for selecting the specification plans of the quantitative worth is received in the quantitative level input area 164e.

In the embodiment, a mark or a character string indicative of the unit is inputted to the unit input area 164d.

The inputting to the quantitative level input area 164e is made by inputting an execution instruction designating a level addition button display area 164f through the input unit 140, so that a new row is produced uppermost in the quantitative level input area 164e and each of the current rows moves down to a one-row lowered row successively so that the level number in the level number column of the one-row lowered row is incremented by “1”. The number of “1” is displayed in the uppermost row.

The operator of the analysis apparatus 100 inputs necessary values to lower and upper limit columns of the newly produced row through the input unit 140 to thereby input the specification plan of the quantitative worth.

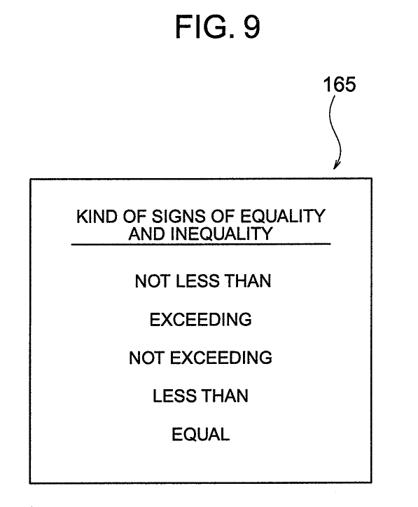

In the embodiment, with regard to the relation of the sings of equality and inequality as to whether the value inputted in the quantitative level input area 164e is contained in the upper or lower limit, information stored in a sign-of-equality-and-inequality selection table 165 as shown in FIG. 9, for example, can be selected in a pull-down menu manner.

On the other hand, when the operator of the analysis apparatus 100 selects the qualitative worth, input of a level of selection items for selecting the specification plans of the qualitative worth is received in the qualitative level input area 164g.

The inputting to the qualitative level input area 164g is made by inputting an execution instruction designating the level addition button display area 164f through the input unit 140, so that a new row is produced uppermost in the qualitative level input area 164g and each of the current rows moves down to a one-row lowered row successively so that the level number in the level number column of the one-row lowered row is incremented by “1”. The number of “1” is displayed in the uppermost row.

The operator of the analysis apparatus 100 inputs information for identifying the qualitative worth to the newly produced row through the input unit 140, so that the specification plan of the qualitative worth is inputted.

When the operator of the analysis apparatus 100 inputs necessary information and then inputs an execution instruction designating an OK button display area 164h, the needs relation definition unit 111 displays a worth class name node 160l that is a worth class node having a name inputted in the node name input area 164a and worth class level nodes 160m, 160n and 160o that are worth class nodes for each level inputted to the quantitative level input area 164e or the qualitative level input area 164g onto the campus area 160b as shown in FIG. 4. The worth class name node 160l and the worth class level nodes 160m, 160n and 160o are connected through arrows shown by broken lines in order to show the correspondence therebetween.

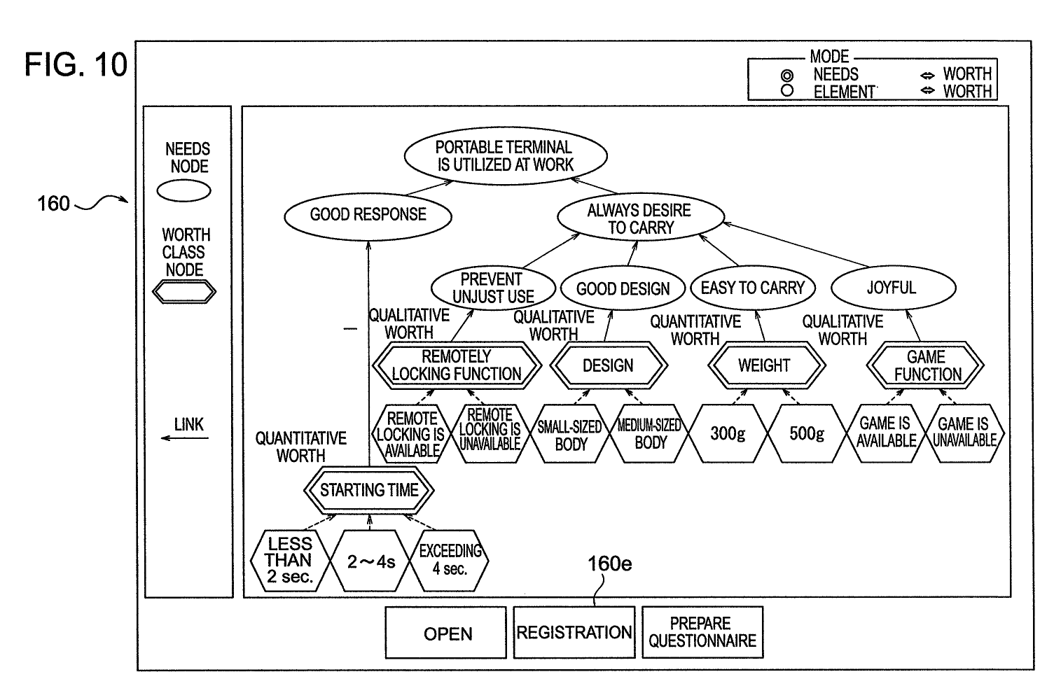

FIG. 10 illustrates an image displayed when the operator of the analysis apparatus 100 inputs information for specifying the needs relative to the product, the causal relationship among the needs, the worth such as function and property of the product relative to the needs and the strength of the relation between the needs and the worth by means of nodes and the links as described above.

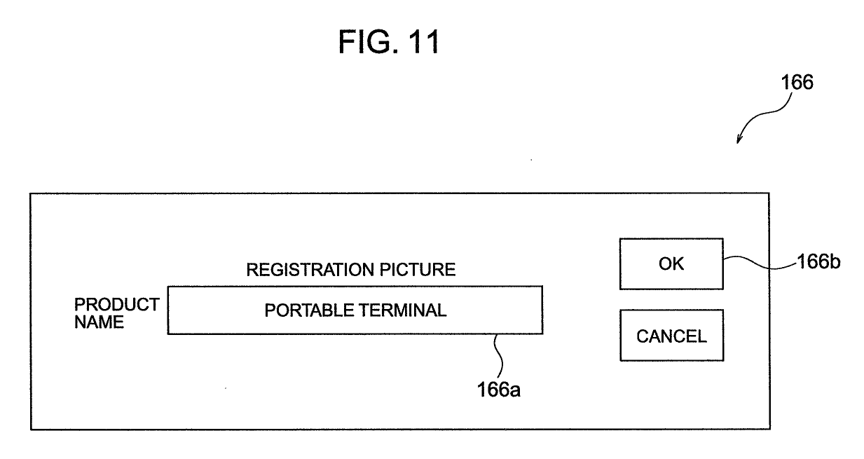

Returning now to FIG. 3, when the operator of the analysis apparatus 100 selects the registration button display area 160e and inputs an execution instruction by means of the input unit 140, the needs relation definition unit 111 displays a registration picture 166 as shown in FIG. 11 onto the output unit 150. When the operator of the analysis apparatus 100 inputs the name of the product of which the needs and the worth are inputted into a product name input area 166a and then inputs the execution instruction designating an OK display area 166b by means of the input unit 140, the needs relation definition unit 111 converts the information inputted through the needs input picture 160 into a predetermined format to send the information to the memory 120, so that the information is stored in the memory 120 (step S11).

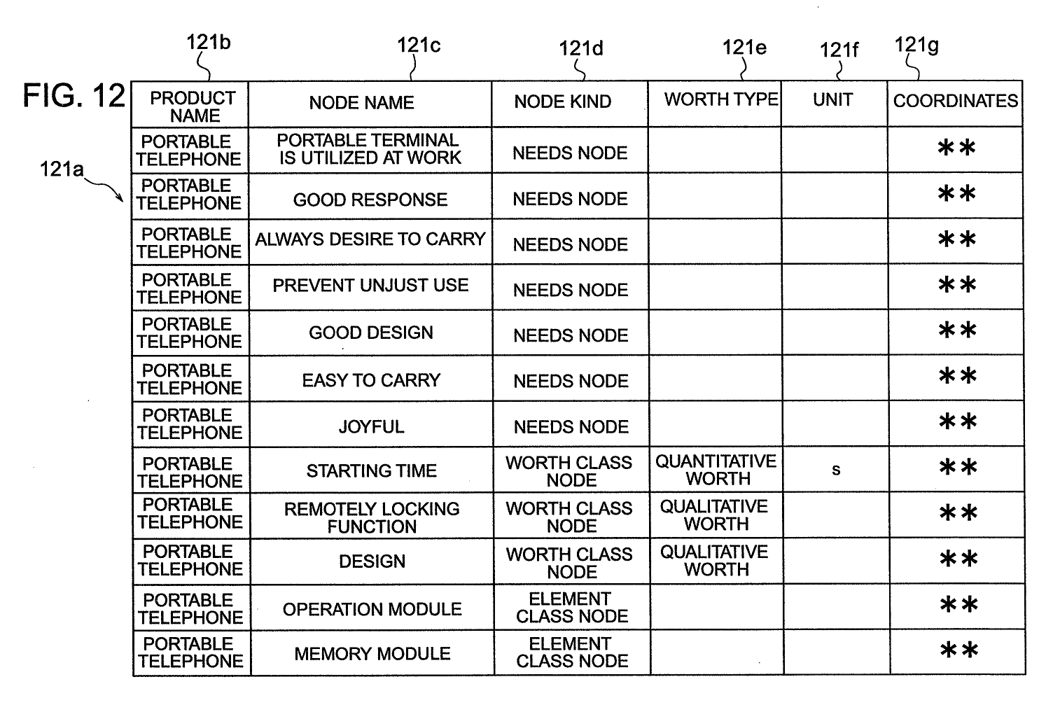

In the embodiment, the information inputted in the needs input picture 160 is converted into table information as shown in FIGS. 12 to 14 to be stored in the memory 120.

FIG. 12 shows a node table 121a.

The node table 121a includes a product name column 121b, a node name column 121c, a node kind column 121d, a worth type column 121e, a unit column 121f and a coordinates column 121g.

The product name column 121b stores information for specifying the name of the product inputted through the registration picture 166.

The node name column 121c stores information for specifying the names of the nodes.

The node kind column 121d stores information for specifying the kinds of the nodes specified by the node name column 121c. In the embodiment, information capable of identifying needs nodes, worth class nodes and element class nodes (described later) can be stored in the node kind column 121d.

The worth type column 121e stores information for specifying whether the worth indicated by the node specified by the node name column 121c is quantitative worth or qualitative value when the kind of the node identified by the node kind column 121d is the worth class node. When the kind of the node is not the worth class node, the worth type column is blank.

The unit column 121f stores information for specifying the unit of the quantitative worth indicated by the node specified by the node name column 121c when the worth of the node identified by the worth type column 121e is the quantitative worth.

The coordinates column 121g stores information for specifying the coordinates in the campus area 160b of the node specified by the node name column 121c.

The node table 121a is stored in the node table memory area 121 of the memory 120.

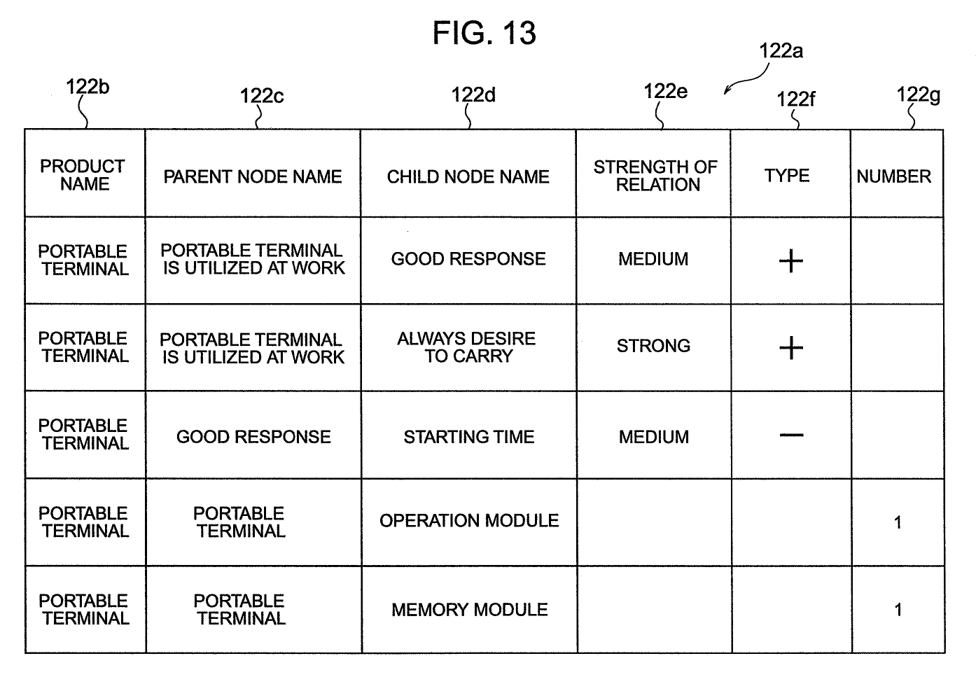

FIG. 13 shows a needs link table 122a.

The needs link table 122a includes a product name column 122b, a parent node name column 122c, a child node name column 122d, a strength-of-relation column 122e, a type column 122f and a number column 122g.

The product name column 122b stores information for specifying the name of the product inputted through the registration picture 166.

The parent node name column 122c stores information for specifying the name of the node connected to the end of the arrow, of the nodes related to the link object 160i in the campus area 160b.

The child node name column 122d stores information for specifying the name of the node connected to the starting point of the arrow, of the nodes related to the link object 160i in the campus area 160b.

The strength-of-relation column 122e stores information for specifying the strength of relation selected in the strength-of-relation input area 162a of the link setting picture 162.

The type column 122f stores information for specifying the strength of relation selected in the type input area 162a of the link setting picture 162.

The number column 122g stores information for specifying the number of nodes specified in the child node name column 122d.

The needs link table 122a is stored in the needs link table memory area 122 of the memory.

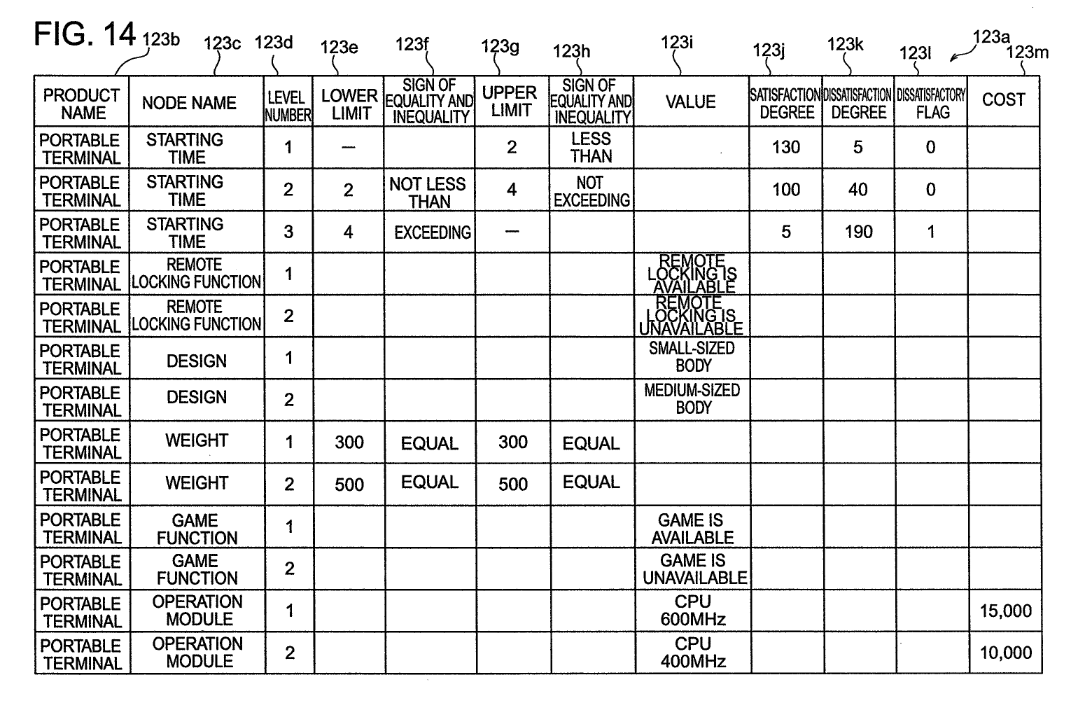

FIG. 14 shows a specification plan table 123a.

The specification plan table 123a includes a product name column 123b, a node name column 123c, a level number column 123d, a lower limit column 123e, a sign-of-equality-and-inequality column 123f, an upper limit column 123g, a sign-of-equality-and-inequality column 123h, a value column 123i, a satisfaction degree column 123j, a dissatisfaction degree column 123k, a dissatisfactory flag column 123l and a cost column 123m.

Information inputted through the worth class node setting picture 164, the satisfaction degree, the dissatisfaction degree and the dissatisfactory flag calculated by the result inputted through a need-related questionnaire 167 described later and information for specifying the prices of elements are stored in the specification plan table 123a.

The product name column 123b stores information for specifying the name of the product inputted through the registration picture 166.

The node name column 123c stores information for specifying the name of the worth class node.

The level number column 123d stores information for specifying the level of the worth class node specified by the node name column 123c.

The lower limit column 123e stores information for specifying a lower limit inputted to the row specified in the level number column 123d of the quantitative level input column 164e in the worth class node specified in the node name column 123c.

The sign-of-equality-and-inequality column 123f stores information for specifying the sign of equality or inequality selected to specify whether the lower limit specified in the lower limit column 123e is contained or not.

The upper limit column 123g stores information for specifying an upper limit inputted to the row specified in the level number column 123d of the qualitative level input column 164e in the worth class node specified in the node name column 123c.

The sign-of-equality-and-inequality column 123h stores information for specifying the sign of equality or inequality selected to specify whether the upper limit specified in the upper limit column 123g is contained or not.

The value column 123i stores information for specifying the value inputted in the row specified in the level number column 123d of the qualitative level input column 164g in the worth class node specified in the node name column 123c.

The satisfaction degree column 123j stores information for specifying the number of times that the worth specified in the lower and upper limit columns 123e and 123g is judged to be satisfactory in the needs-related questionnaire described later in the worth class node specified in the node name column 123c.

The dissatisfaction degree column 123k stores information for specifying the number of times that the worth specified in the lower and upper limit columns 123e and 123g is judged to be dissatisfactory in the needs-related questionnaire in the worth class node specified in the node name column 123c.

The dissatisfactory flag column 123l stores “1” when the number of times that the worth specified in the lower and upper limit columns 123e and 123g is judged to be dissatisfactory exceeds a predetermined judgment reference and stores “0” when it does not exceed the reference from the totalized result of the numbers of times that it is judged to be satisfactory or dissatisfactory in the worth class node specified in the node name column 123c. The dissatisfactory flag is described in detail later.

The cost column 123m stores information for specifying the worth of the node specified in the node name column 123c.

The specification plan table 123a is stored in the specification plan table memory area 123 of the memory 120.

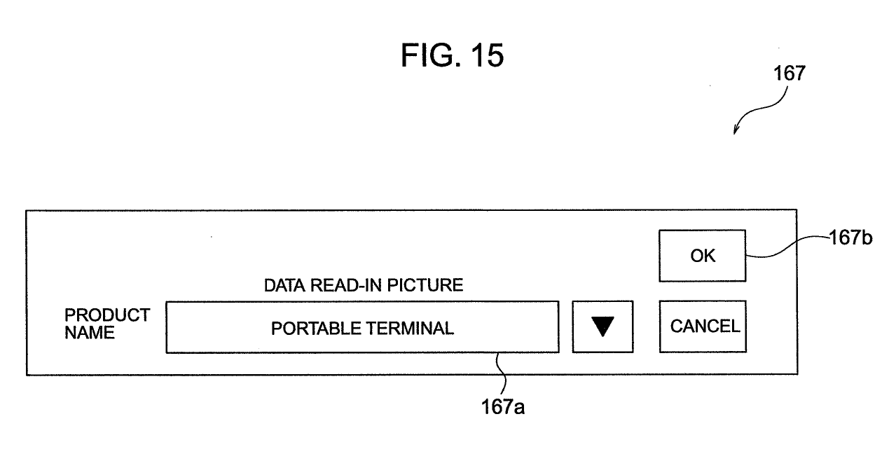

When information stored in the node table 121a, the needs link table 122a and the specification plan table 123a stored in the memory 120 is read out, an execution instruction designating the open button display area 160d of the needs registration picture 160 as shown in FIG. 4 is inputted by means of the input unit 140, so that a data read-in picture 167 as shown in FIG. 15 is displayed in the output unit 150.

Then, the operator of the analysis apparatus 100 inputs information for specifying the name of the product of data to be read in a product name input area 167a of the data read-in picture 167 by means of the input unit 140 and then inputs an execution instruction designating an OK button display area 167b, so that corresponding data can be displayed in the output unit 150 in a predetermined format and the operator can make retouching, correction and the like of the displayed data by means of the input unit 140.

Returning now to FIG. 3, the needs estimation unit 112 prepares the needs-related questionnaire used to make an investigation related to the needs from the customers on the basis of information stored in the memory 120 (step S12).

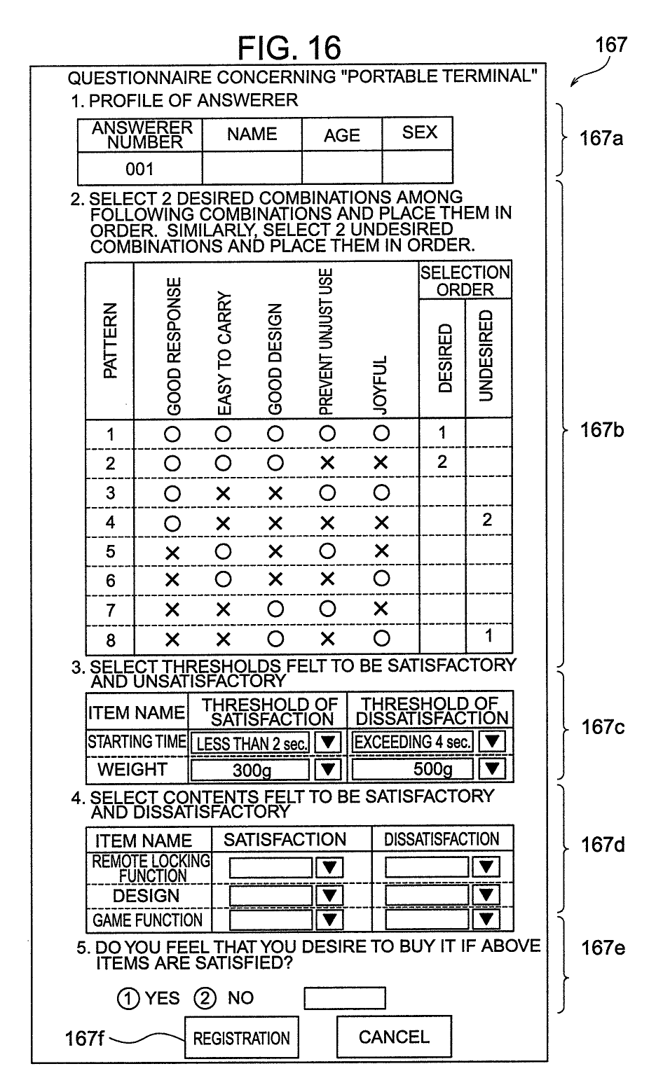

FIG. 16 shows a needs-related questionnaire prepared by the needs estimation unit 112.

The needs-related questionnaire 167 includes a profile part 167a, a pattern selection part 167b, a quantitative worth selection part 167c, a qualitative worth selection part 167d and a purchasing desire part 167e.

Name, age and sex of an answerer to the needs-related questionnaire are described or inputted in the profile part 167a by the answerer to get the profile of the answerer.

Information for specifying desired combinations and undesired combinations of the needs is described or inputted in the pattern selection part 167b by the answerer to the needs-related questionnaire to get the strength of the needs from the combined patterns of the needs.

Information for specifying thresholds felt to be satisfactory and thresholds felt to be dissatisfactory in the quantitative worth related to the needs is described or inputted in the quantitative worth selection part 167c to get the taste for the quantitative worth of the product.

Information for specifying items felt to be satisfactory and items felt to be dissatisfactory in the qualitative worth related to the needs is described or inputted in the qualitative worth selection part 167d to get the taste for the qualitative worth.

Information for specifying whether there is purchasing desire or not when the worth described or inputted in the quantitative worth selection part 167c and the qualitative worth selection part 167d is satisfied is described or inputted in the purchasing desire part 167e to get the purchasing desire for the product.

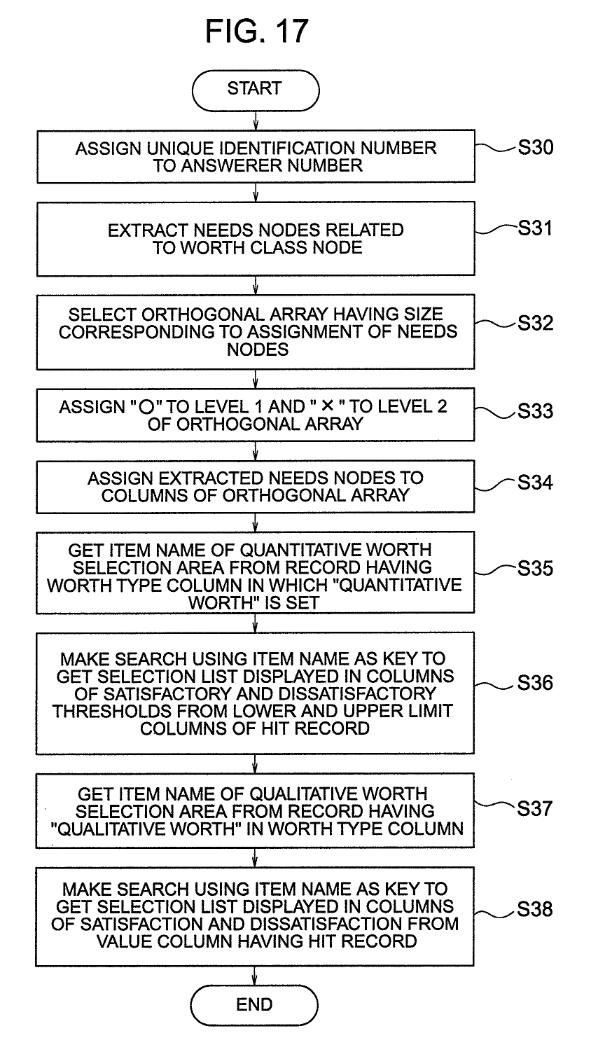

FIG. 17 is a flowchart showing processing of preparing the needs-related questionnaire 167 by the needs estimation unit 112.

First, the needs estimation unit 112 assigns identification information (answerer number) for uniquely identifying the answerer to the answerer and stores it in an answerer number column of the profile part 167a (step S30). The profile part 167a includes a name column, an age column and a sex column in addition and since these columns are described or inputted by the answerer, the columns are made to be blank.

Next, the needs estimation unit 112 extracts the needs nodes related to the worth class node from the node table 121a and the needs link table 122a (step S31).

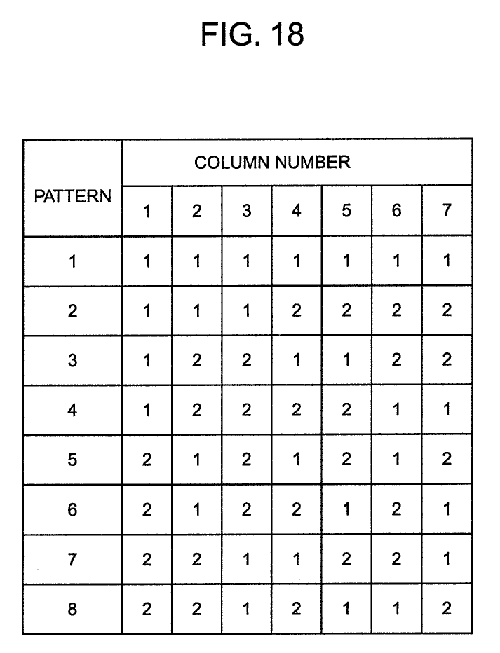

The needs estimation unit 112 selects a minimum orthogonal array in which the needs nodes extracted in step S31 can be assigned to columns (step S32). In the example shown in FIG. 10, since the number of nodes related to the worth class node is 5 (“good response”, “easy to carry”, “good design”, “prevent unjust use” and “joyful”), the orthogonal array of L8 as shown in FIG. 18, for example, is selected.

The needs estimation unit 112 assigns “◯” to level 1 and “×” to level 2 of the orthogonal array selected in step S32 (step S33).

The needs estimation unit 112 assigns the needs nodes extracted in step S31 to the columns of the orthogonal array selected in step S32 in a predetermined order (step S34).

The pattern selection part 167b of the needs-related questionnaire 167 can be prepared or produced by the processing of steps S31 to S34.

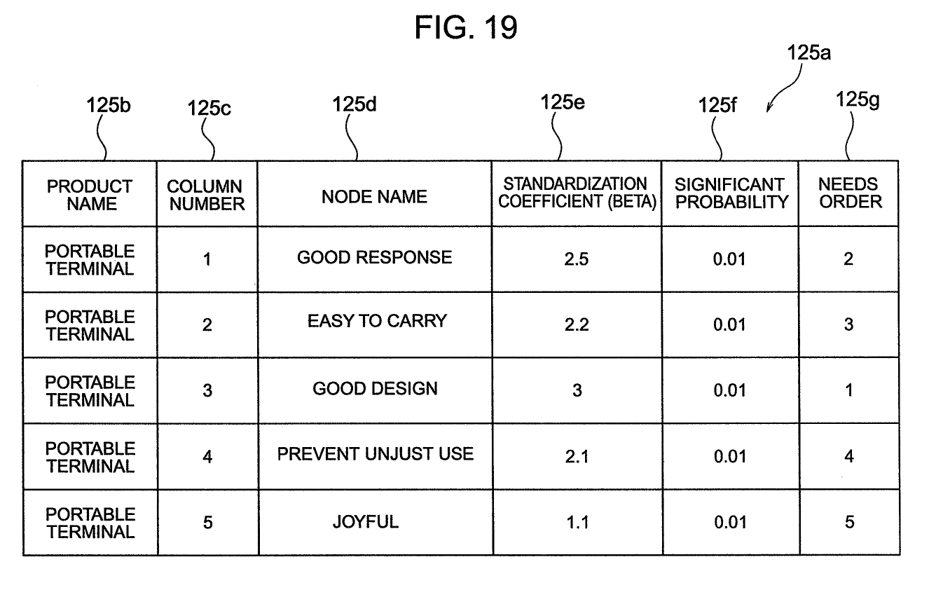

In this case, the needs estimation unit 112 prepares or produces a node name table (refer to FIG. 19) for specifying the assignment of the needs nodes performed in step S34 and stores it in the node name table memory area 125 of the memory 120.

FIG. 19 shows the node name table 125a.

As shown in FIG. 19, the node name table 125a includes a product name column 125b, a column number column 125c, a node name column 125d, a standardization coefficient column 125e, a significant probability column 125f and a needs order column 125g.

The product name column 125b stores the name of the product for which a needs-related questionnaire is prepared. The name is specified by the name of the product inputted through the registration picture 166.

The column number column 125c stores information for specifying the column of the orthogonal array to which the needs node specified in the node name column 125d described later is assigned.

The node name column 125d stores information for specifying the name of the needs node assigned to the column of the orthogonal array specified in the column number column 125c.

The standardization coefficient column 125e stores information for specifying the standardization coefficient calculated by the needs estimation unit 112. The calculation method of the standardization coefficient is described later.

The significant probability column 125f stores information for specifying the significant probability calculated by the needs estimation unit 112. The calculation method of the significant probability is described later.

The needs order column 125g stores information for specifying the needs order of the needs node specified in the node name column 125d. The needs order is decided by the needs estimation unit 112 and the decision method is described later.

Returning now to FIG. 17, the needs estimation unit 112 gets the node name from the node name column 121c of the record having the worth type column 121e of the node table 121a in which “quantitative worth” is set and sets it as the item name in the quantitative worth selection area 167c of the needs-related questionnaire 167 (step S35).

The needs estimation unit 112 searches the node name column 123c of the specification plan table 123 while using the node name set as the item name in step S35 as a key to get values stored in the lower limit column 123e and the upper limit 123g having hit record, so that the values stored in the lower limit column 123e and the upper limit 123g are set as selection list displayed in columns of the satisfactory and dissatisfactory thresholds in the quantitative worth selection area 167c of the needs-related questionnaire 167 (step S36).

The quantitative worth selection area 167c of the needs-related questionnaire can be prepared or produced by the processing of steps S35 and S36.

The needs estimation unit 112 get the node name from the node name column 121c of the record having the worth type column 121e of the node table 121a in which “qualitative worth” is set and sets it as the item name in the qualitative worth selection area 167d of the needs-related questionnaire 167 (step S37).

The needs estimation unit 112 searches the node name column 123c of the specification plan table 123 while using the node name set as the item name in step S37 as a key to get value stored in the value column 123i having hit record, so that the value stored in the column 123i is set as selection list displayed in columns of the satisfactory and dissatisfactory thresholds in the qualitative worth selection area 167d of the needs-related questionnaire 167 (step S38).

The processing of steps S37 and S38 can prepare or produce the qualitative worth selection area 167d of the needs-related questionnaire 167. For the purchasing desire part 167e, a blank column in which selection information can be inputted may be provided previously.

Returning now to FIG. 3, the needs-related questionnaire 167 prepared as above is stored in the needs-related questionnaire memory area 124 of the memory 120.

The needs estimation unit 112 displays the needs-related questionnaire 167 stored in the questionnaire memory area 124 of the memory 120 onto the output unit 150 to receive necessary input information and performs needs investigation processing to be stored in the memory 120 (step S14).

More particularly, the needs estimation unit 112 displays the needs-related questionnaire 167 onto the output unit 150 to receive necessary input information and receives an execution instruction designating the registration button display area 167f of the needs-related questionnaire 167 through the input unit 140 to thereby store inputted information and information calculated from the inputted information into the memory 120.

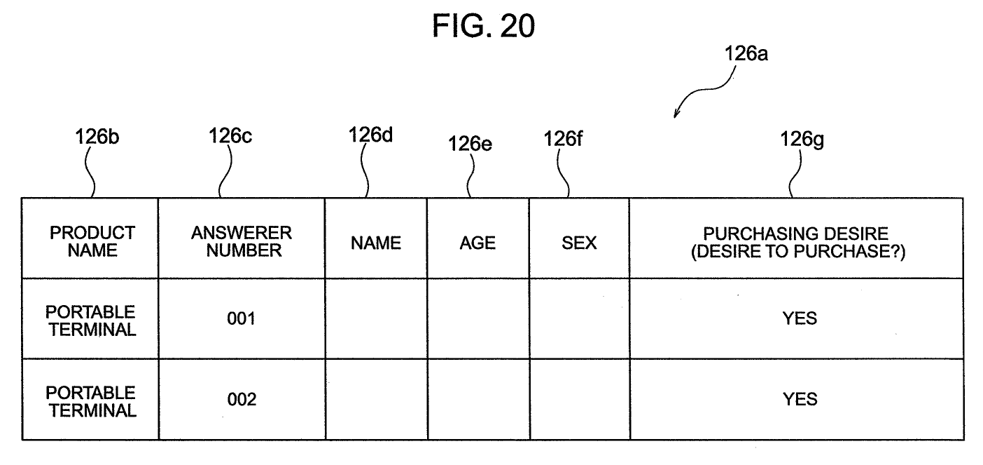

The needs estimation unit 112 stores the information inputted in the profile part 167a and the purchasing desire part 167e of the needs-related questionnaire 167 into a profile table 126a as shown in FIG. 20.

As shown in FIG. 20, the profile table 126a includes a product name column 126b, an answerer number column 126c, a name column 126d, an age column 126e, a sex column 126f and a purchasing desire column 126g.

The product name column 126b stores information for specifying the name of the product to be investigated by the needs-related questionnaire 167. The information stored in this column is specified by the name of the product inputted through the registration picture 166.

The answerer number column 126c stores identification information (answerer number) for identifying the answerer. Information inputted in the answerer number column of the profile part 167a of the needs-related questionnaire 167 is stored in this column.

The name column 126d stores information for specifying the name of the answerer. Information inputted in the name column of the profile part 167a of the needs-related questionnaire 167 is stored in this column.

The age column 126e stores information for specifying the age of the answerer. Information inputted in the age column of the profile part 167a of the needs-related questionnaire 167 is stored in this column.

The sex column 126f stores information for specifying the sex of the answerer. Information inputted in the sex column of the profile part 167a of the needs-related questionnaire 167 is stored in this column.

The purchasing desire column 126g stores information for specifying the purchasing desire of the answerer. Information selected in the purphasing desire part 167e of the needs-related questionnaire is stored in this column.

It is supposed that the profile table 126a is previously stored in the profile table memory area 126 of the memory 120.

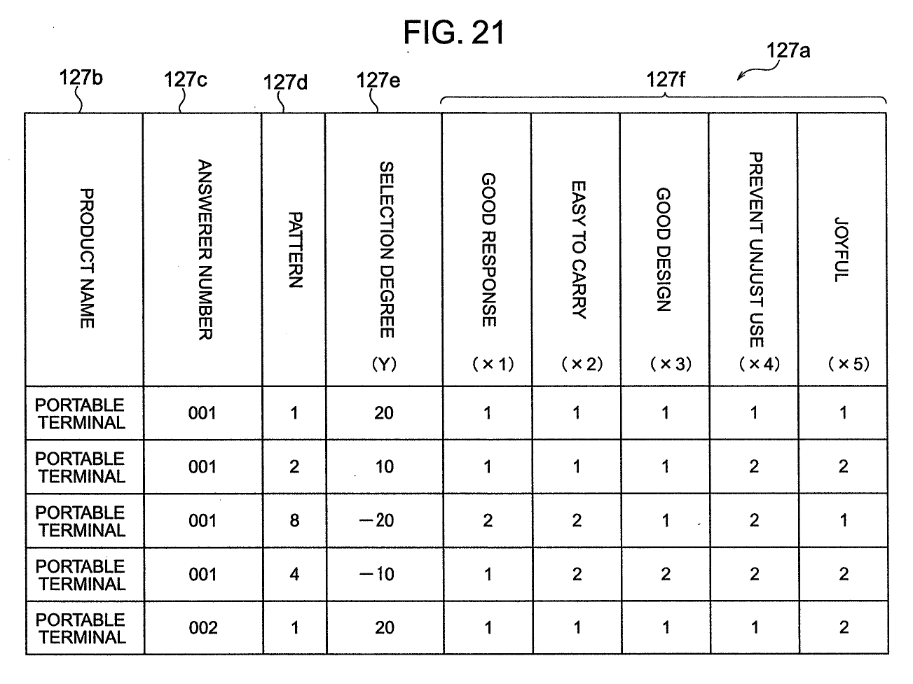

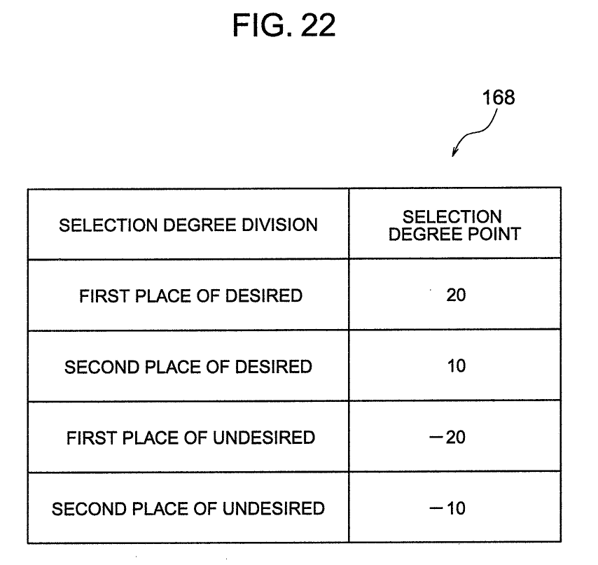

The needs estimation unit 112 stores the pattern, the selection degree and values (x1, x2, . . . , xn) of the orthogonal array of the row selected to be “desired” or “undesired” in the selection order column in the pattern selection part 167b of the needs-related questionnaire 167 by the answerer into a needs pattern selection table 127a as shown in FIG. 21. The numerical value corresponding to the selection order inputted by the operator of the analysis apparatus 100 is gotten from a selection degree table 168 as shown in FIG. 22 to be stored as the selection degree.

FIG. 21 shows the needs pattern selection table 127a.

As shown in FIG. 21, the needs pattern selection table 127a includes a product name column 127b, an answerer number column 127c, a pattern column 127d, a selection degree column 127e and an orthogonal array column 127f.

The product name column 127b stores information for specifying the name of the product to be investigated by the needs-related questionnaire 167. The information stored in the column is specified by the name of the product inputted through the registration picture 166.

The answerer number column 127c stores identification information (answerer number in the embodiment) for specifying the answerer who gives an answer to the needs-related questionnaire 167. The information inputted to the answerer number column of the profile part 167a of the needs-related questionnaire 167 is stored as the information stored in this column.

The pattern column 127d stores information for specifying the pattern of values (levels) in the orthogonal array stored in the orthogonal array column 127f described later. Information inputted in the pattern column of the pattern selection part 167b of the needs-related questionnaire 167 is stored as the information stored in this column.

The selection degree column 127e stores value of the selection degree gotten from the selection degree table 168 by the needs estimation unit 112.

The orthogonal array column 127f stores values (levels) of the orthogonal array in the pattern selection part 167b of the needs-related questionnaire 167.

The needs estimation unit 112 specifies the record of the specification plan table 123a stored in the lower limit column 123e or the upper limit column 123e by the value corresponding to the item selected as the satisfactory threshold in the quantitative worth selection part 167c of the needs-related questionnaire 167 and increments the satisfactory degree column 123j of the record by “1”.

The needs estimation unit 112 specifies the record of the specification plan table 123a stored in the lower limit column 123e or the upper limit column 123g by the value corresponding to the item selected as the dissatisfactory threshold in the quantitative worth selection part 167c of the needs-related questionnaire 167 and increments the dissatisfactory degree column 123k of the record by “1”.

Returning now to FIG. 3, the needs estimation unit 112 performs needs estimation processing of estimating the needs on the basis of the information stored in the memory 120 (step S15) and stores the estimated result in the memory 120 (step S16).

Concretely, the needs estimation unit 112 specifies the record indicating that the value stored in the purchasing desire column 126g of the profile table 126a is “Yes”, that is, indicating that the answerer has the purchasing desire and specifies identification information for identifying the answerer from the answerer number column 126c of the specified record.

The needs estimation unit 112 specifies the record in which information corresponding to the specified identification information is stored in the answerer number column 127c of the pattern selection table 127a and performs the multiple regression analysis while using the selection degree (Y) stored in the selection degree column 127e in the specified record as an objective variable and the values (x1, x2, . . . , xn) stored in the orthogonal array column 127f as explanatory variables to get a multiple regression expression as described in the following expression (1).

Y=b1x1+b2x2+b3x3+ . . . +bnxn+b0 (1)

where b0 is a fixed item and b1, b2, . . . , bn are regression coefficients, which can be calculated by coalizing a necessary number of samples in the expression (1).

The significant probability (p value) that is an appearance probability of the regression coefficient is calculated for each regression coefficient (bn).

The needs estimation unit 112 calculates a standard deviation sy for the objective variable (Y) and a standard deviation sn for the explanatory variable (xn) and substitutes the calculated values for those of the following expression (2) to calculate standardization variables (βn).

βn=sn×bn÷sy (n>0) (2)

The needs estimation unit 112 ranks the standardization variables (βn) so that the needs order is heightened in order of the absolute value of the standardization variable (βn) to be stored in the needs order column 125g of the node name table 125a. It is supposed that the standardization coefficients (βn) are stored in case where the significant probability (p value) is equal to or smaller than 0.05.

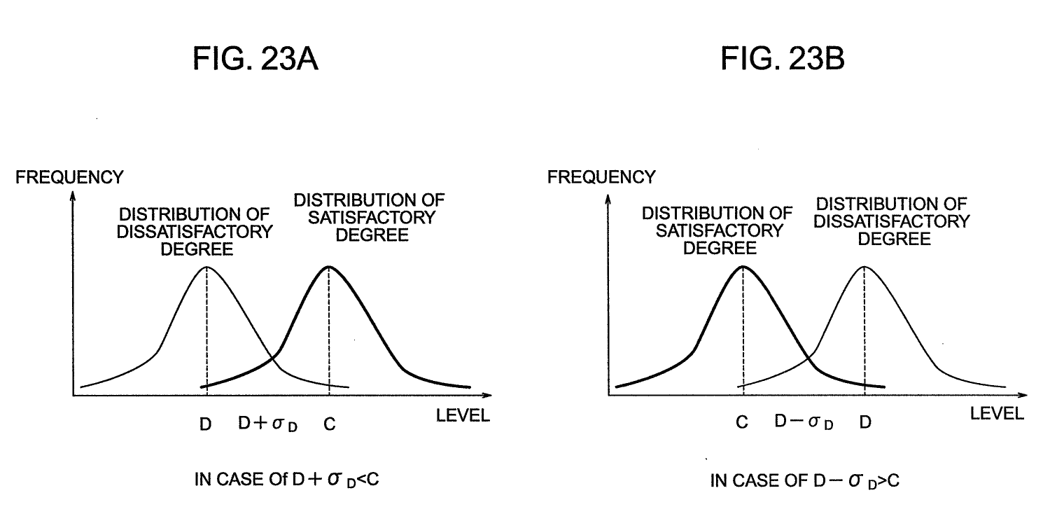

Further, the needs estimation unit 112 prepares satisfactory degree distribution (average level C of satisfaction) and dissatisfactory degree distribution (average level D of dissatisfaction and standard deviation level σD of dissatisfaction) as shown in FIGS. 23A and 23B, for example, for each of the node names of the specification plan table 123a.

The needs estimation unit 112 sets the value of the dissatisfactory flag 123l of the specification plan table 123a to “1” when the sum of D and σD is smaller than C or when the difference between D and σD exceeds C and sets the value of the dissatisfactory flag column 123l to “0” when the above conditions are not satisfied.

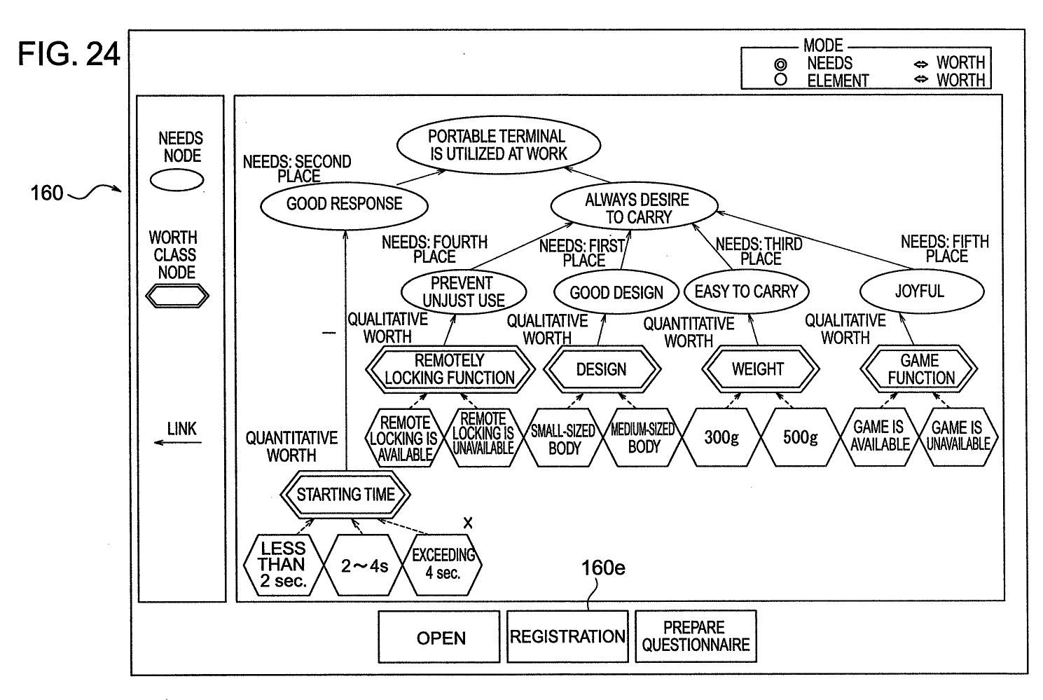

The needs order calculated in the needs estimation unit 112 as described above is displayed in the output unit 150 in a predetermined format by means of the needs relation definition unit 111. For example, the needs relation definition unit 111 displays information indicating the needs order in a position (upper left position of the needs node in the embodiment) adjacent to the needs node related to the worth class node in the needs node setting picture 161 as shown in FIG. 24. In FIG. 24, the needs relation definition unit 111 displays a mark of “×” in a position (upper right position of the worth class node in the embodiment) adjacent to the worth class node having the dissatisfactory flag column 123l of the specification plan table 123a that is set to “1”.

As described above, the operator of the analysis apparatus 100 can grasp weak needs (e.g. game function) or specification value apt to be kept at a distance (e.g. the starting time exceeding 4 sec.) before development of the product.

Since the strength of the needs can be also judged objectively, the product having the target performance meeting the needs in the market can be developed.

Returning now to FIG. 3, the element relation definition unit 113 receives input information expressing constitution of elements such as hardware components and software components constituting the product and relation of the elements and worth items by means of nodes and links from the operator of the analysis apparatus 100 (step S17).

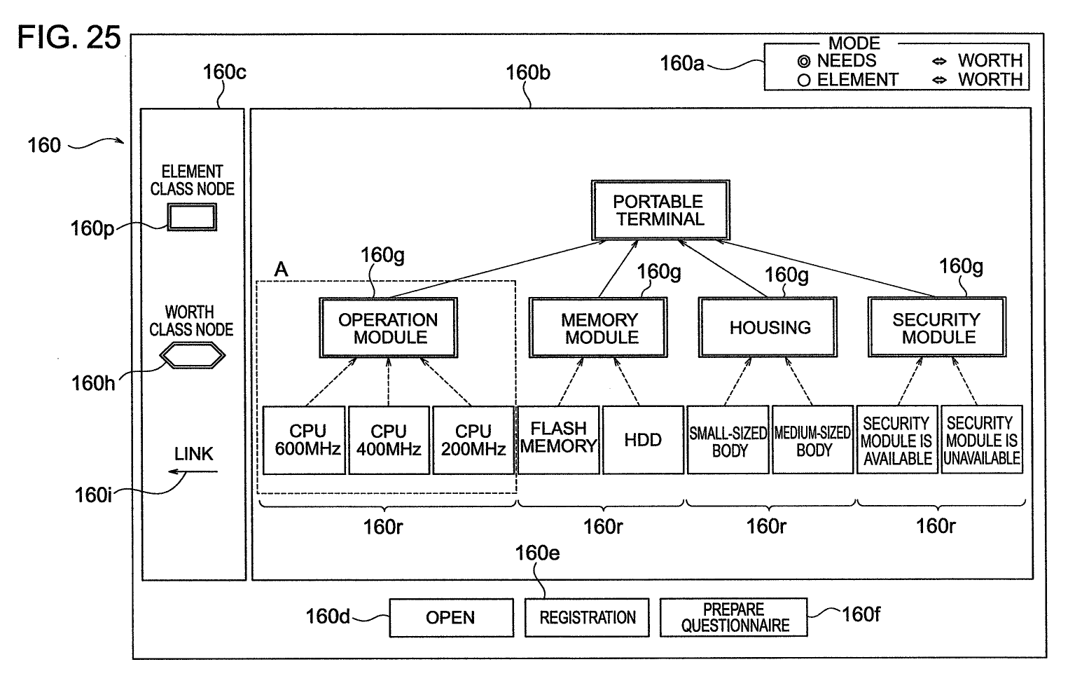

For example, when the element relation definition unit 113 selects to input information relative to the elements in the mode selection area 160a of the needs input picture 160 as shown in FIG. 25, element class node object 160p, worth class node object 160h and link object 160i are displayed in the palette area 160e.

The operator of the analysis apparatus 100 drags and drops the objects displayed in the palette area 160c onto the campus area 160b by means of the input unit 140 to thereby input the constitution of elements and the relation of the elements and the worth items.

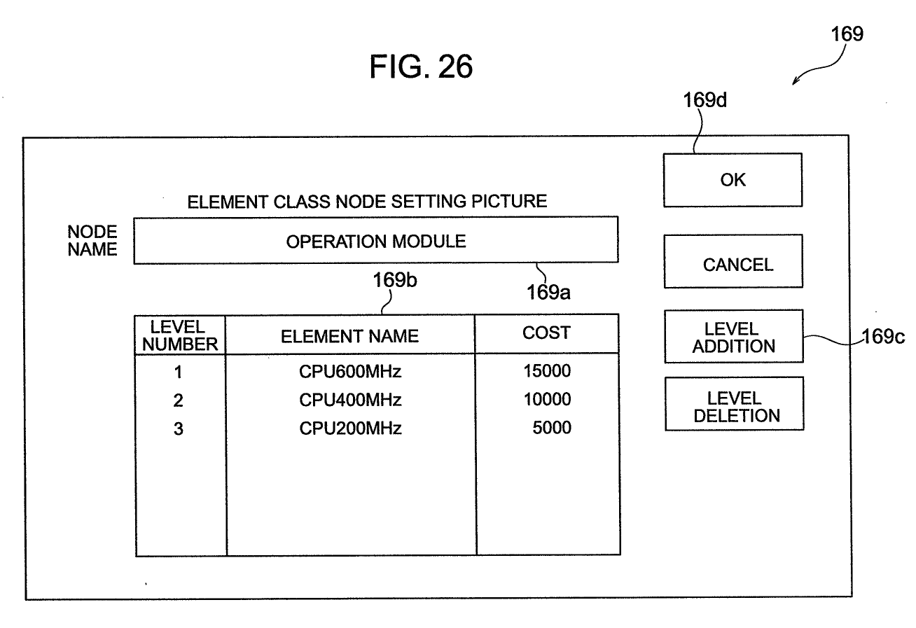

Concretely, when the operator of the analysis apparatus 100 drags and drops the element class node object 160p displayed in the palette 160c onto the campus area 160b by means of the input unit 140, the element relation definition unit 113 displays an element class node setting picture 169 as shown in FIG. 26 onto the output unit 150.

The operator of the analysis apparatus 100 inputs a name for generally specifying an element (component), such as a general name of the component of the product constituting the element to a node name input area 169a of the element class node setting picture 169 as the node name by means of the input unit 140 and inputs the name of the concrete element for specifying the specification, of selection items for selecting use and performance of the element and a price (cost) of the concrete element to an element level input area 169b.

The inputting to the element level input area 169b is made by inputting an execution instruction designating a level addition button display area 169c by means of the input unit 140, so that a new row is produced uppermost in the element level input area 169b, so that each of the current rows moves down to a one-row lowered row successively and the level number in the level number column of the one-row lowered row is incremented by “1” (“1” is displayed in the level number of the uppermost row).

The operator of the analysis apparatus 100 inputs a name and a cost of the element to the element name column and the cost column of the newly produced row by means of the input unit 140.

The operator of the analysis apparatus 100 inputs an execution instruction by means of the input unit 140 while designating an OK button display area 169d, so that element class nodes 160g and element level nodes 160r are displayed in the campus area 160b of the needs input picture 160.

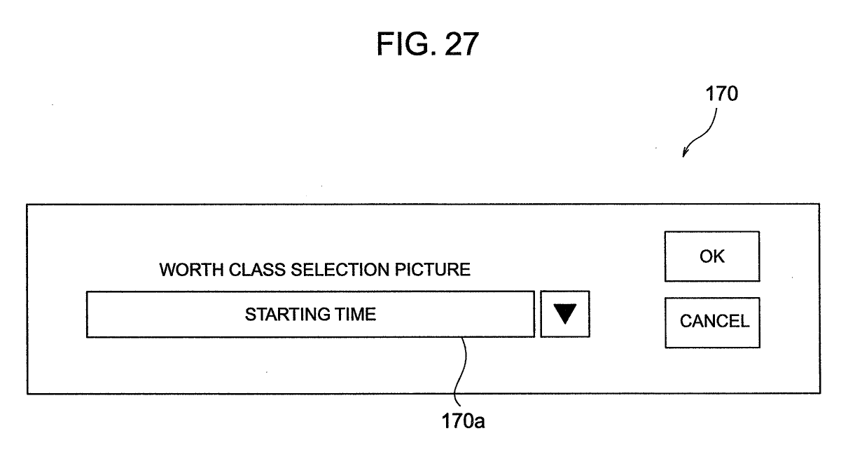

When the operator of the analysis apparatus 100 drags and drops the worth class node object 160h displayed in the palette area 160c onto the campus area 160b by means of the input unit 140, the element relation definition unit 113 displays a worth class selection picture 170 as shown in FIG. 27 onto the output unit 150.

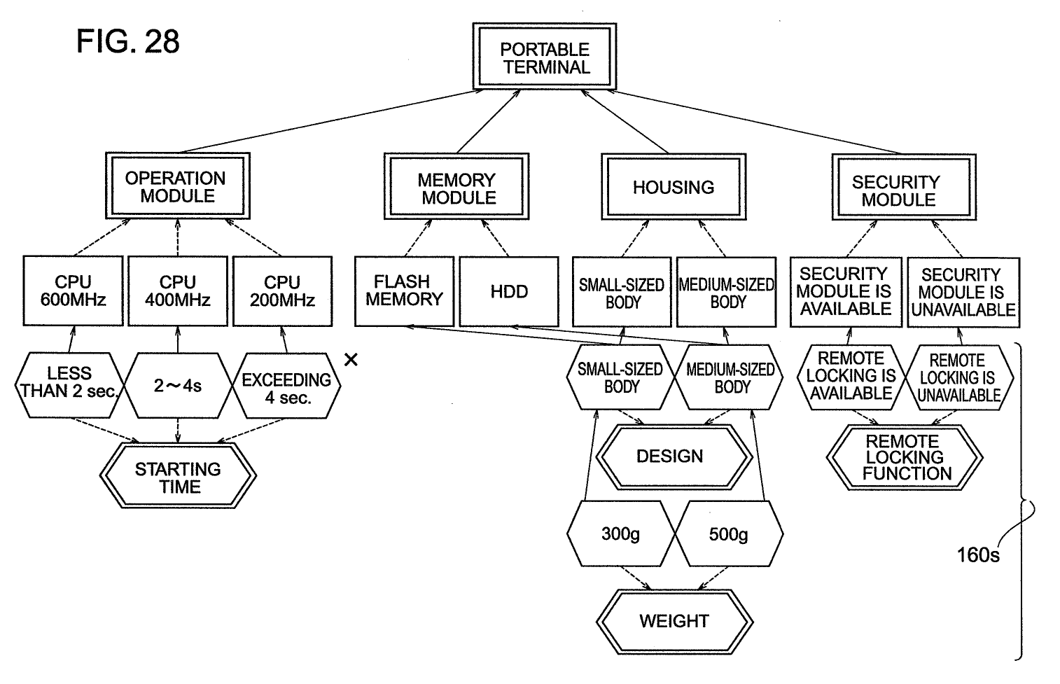

When the operator of the analysis apparatus 100 selects the name of the worth class node for relating to the element node in a worth class selection area 170a of the worth class selection picture 170 by means of the input unit 140, worth class nodes 160s are displayed in the campus area 160b as shown in FIG. 28.

The operator of the analysis apparatus 100 prepares a link connecting between nodes if necessary to thereby define the relation therebetween. For example, the operator of the analysis apparatus 100 selects the link object 160i in the palette area 160c by means of the input unit 140. Then, the operator selects a node at a starting point of a link, displayed in the campus area 160b and then selects a node at an end point of the link, so that the link can be stretched or connected between the selected nodes.

Returning now to FIG. 3, when the operator of the analysis apparatus 100 selects the registration button display area 160e and inputs the execution instruction, the information inputted through the campus area 160b is stored in the memory 120 (step S18).

Concretely, the names of the element class nodes 160g and the element level nodes 160r, the kinds of nodes (element nodes) and the coordinates inputted through the campus area 160b are stored in the node name column 121c, the node kind column 121d and the coordinates column 121g of the node table 121a, respectively.

Further, the names of the element class nodes 160g, the names of the element level nodes 160r and the number of the element level nodes 160r inputted through the campus area 160b are stored in the parent node name column 122c, the child node name column 122d and the number column 122g of the worth link table 122a, respectively.

The names and the level numbers of the element class node 160g and the name and the cost of the element level node 160r inputted through the campus area 160b are stored in the node name column 123c, the level number column 123d, the value column 123i and the cost column 123m of the specification plan table 123a, respectively.

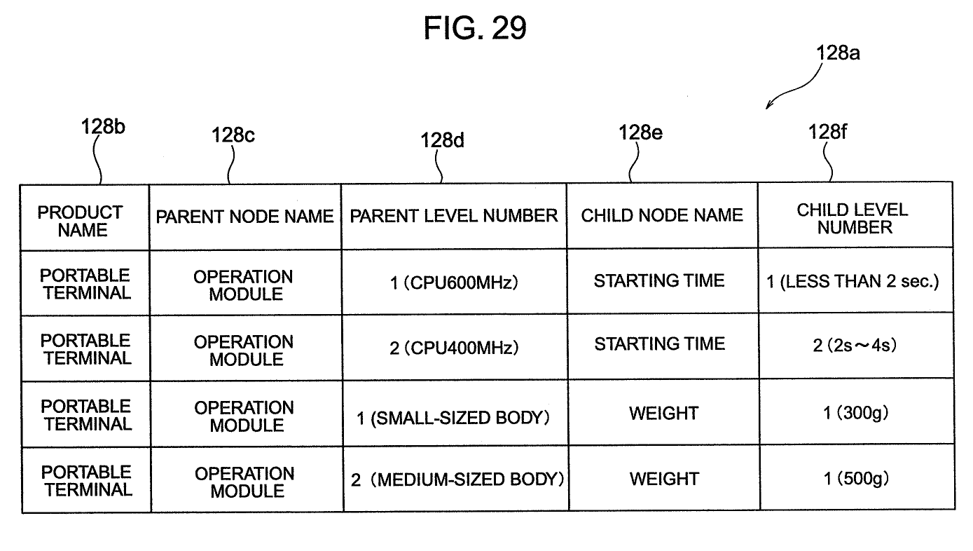

Moreover, the relation between the element level node 160r and the worth class level node inputted through the campus area 160b is stored in an element link table 128a (refer to FIG. 29) stored in the element link table memory area 128.

As shown in FIG. 29, the element link table 128a includes a product name column 128b, a parent node name column 128c, a parent level number column 128d, a child node name column 128e and a child level number column 128f.

The product name column 128b stores information for specifying the name of the product inputted through the registration picture 166.

The parent node name column 128c stores information for specifying the name of the element level node connected to the end point of the arrow, of the nodes related by the link object 160i in the campus area 160b.

The parent level number column 128d stores information for specifying the level of the element level node inputted through the campus area 160b. The level is to be displayed in the level number column of the element level input area 169b of the element class node setting picture 169.

The child node name column 128e stores information for specifying the name of the worth class level node connected to the starting point of the arrow, of the nodes related by the link object 160i.

The child level number column 128f stores information for specifying the level of the worth class level node inputted through the campus area 160b.

Returning now to FIG. 3, the worth estimation unit 114 performs worth-related questionnaire preparation processing of preparing a worth-related questionnaire for calculating or creating the specification formation of the product having high worth as viewed from the customer (step S19).

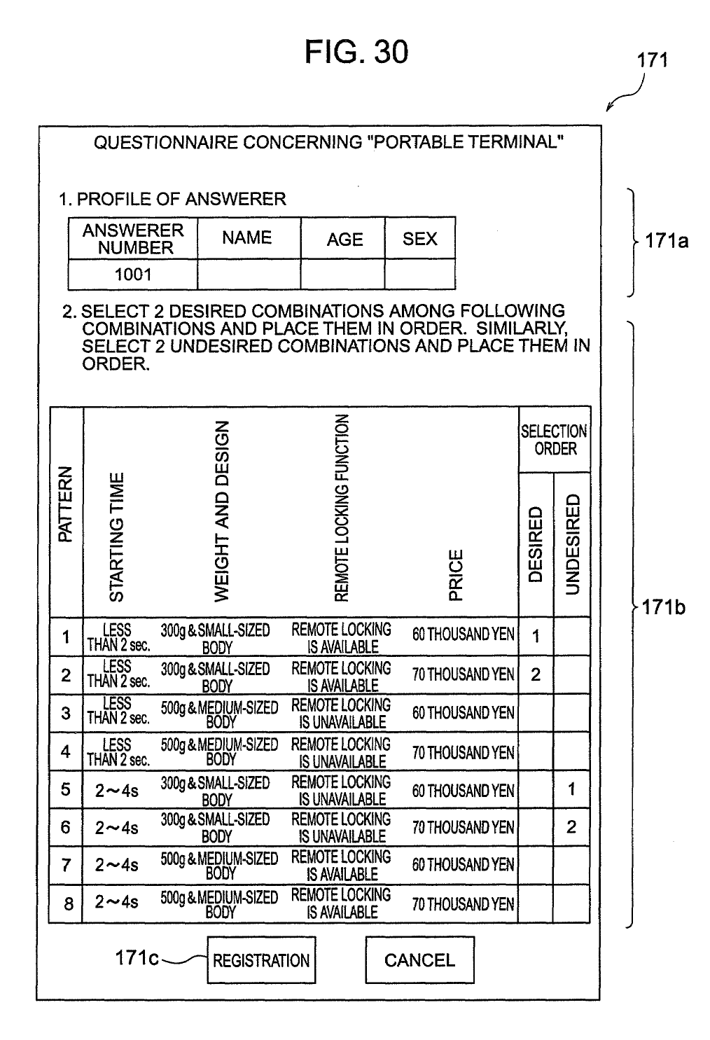

FIG. 30 shows the worth-related questionnaire 171 prepared by the worth estimation unit 114.

As shown in FIG. 30, the worth-related questionnaire 171 includes a profile part 171a and a pattern selection part 171b.

Name, age and sex of an answerer to the worth-related questionnaire 171 are described or inputted in the profile part 171a by the answerer to get the profile of the answerer.

Information for specifying desired combinations and undesired combinations of the specification is described or inputted in the pattern selection part 171b by the answerer to the worth-related questionnaire 171 to get the height of the worth from the combined patterns of the specification.

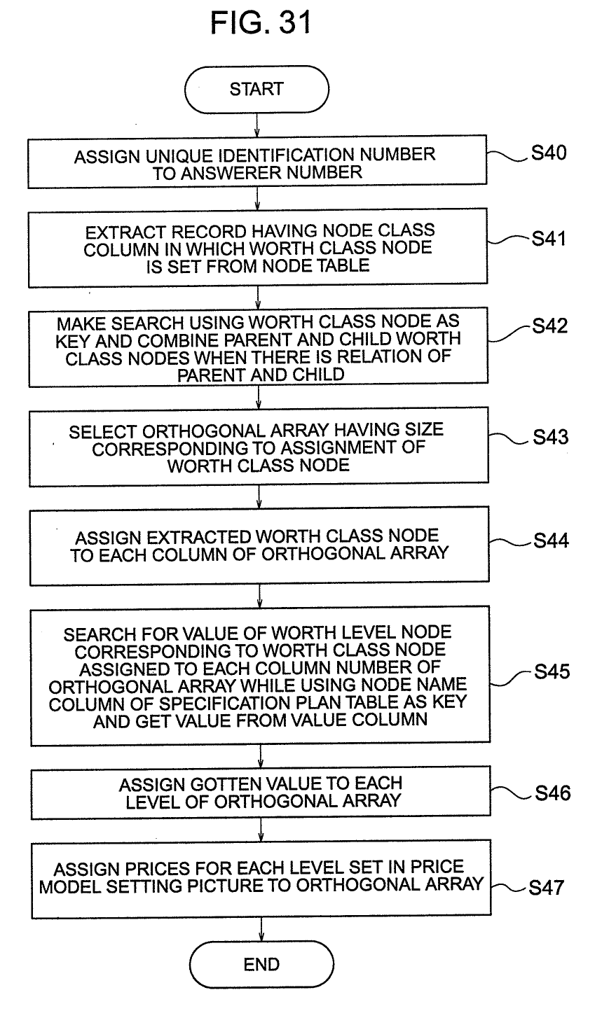

FIG. 31 is a flowchart showing processing of preparing the worth-related questionnaire 171 by the worth estimation unit 114.

First, the worth estimation unit 114 assigns identification information (answerer number) for uniquely identifying the answerer to the answerer and stores it in the answerer number column of the profile part 171a (step S40). The profile part 171a includes the name column, the age column and the sex column in addition and since these columns are inputted by the answerer, these columns are made to be blank.

Next, the worth estimation unit 114 extracts a record having the node kind column 121d in which the worth class node is set from the node table 121a (step S41).

The worth estimation unit 114 searches the needs link table 122a while using the node name stored in the node name column 121c of the record extracted in step S41 as key and combines the parent and child node names when any two node names of the record extracted in step S41 have the relation of parent and child (step S42). Consequently, it is possible to suppress undesired combination in the pattern preparation of question items. In the embodiment, these node names are combined by “&”, for example, although the present invention is not limited thereto.

Next, the worth estimation unit 114 selects a minimum orthogonal array in which the node name (combined node name when combined in step S42) of the worth class node extracted in step S41 can be assigned to the column thereof (step S43) and assigns the node name (combined node name when combined in step S42) of the worth class node extracted in step S41 to each column thereof (step S44).

The worth estimation unit 114 specifies the record of the specification plan table 123a corresponding to the node name assigned in step S44 from the node name column 123c and gets the value from the value column 123i of the specified record (step S45).

The worth estimation unit 114 assigns the value gotten in step S45 to each level of the node name in the record specified in step S45 (step S46).

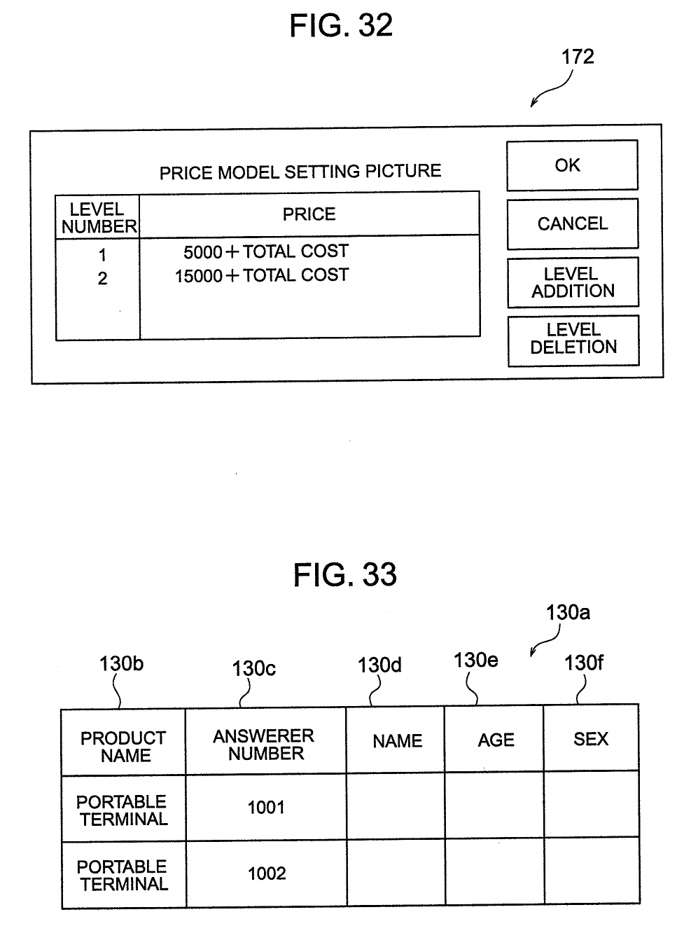

The worth estimation unit 114 displays a price model setting picture 172 as shown in FIG. 32 onto the output unit 150 to receive input of the price for each level through the input unit 140 and assigns the received prices to the orthogonal array (step S47). The “total cost” in FIG. 32 is calculated by extracting the costs of the elements constituting the product from the cost column 123m of the specification plan table 123a and adding them and it is supposed that the total cost is calculated by the worth estimation unit 114.

Returning to FIG. 3, the price-related questionnaire 171 prepared by the above processing is stored in the price-related questionnaire memory area 129 of the memory 120 (step S20).

The worth estimation unit 114 performs the price estimation processing of displaying the price-related questionnaire 171 stored in the worth-related questionnaire memory area 129 of the memory 120 onto the output unit 150 to receive necessary input information and storing it in the memory 120 (step S21).

Concretely, the worth estimation unit 114 displays the price-related questionnaire 171 onto the output unit 150 to receive necessary input information and receives an execution instruction designating the registration button display area 171c of the price-related questionnaire 171 through the input unit 140 to thereby store inputted information and information calculated from the inputted information into the memory 120.

First, the worth estimation unit 114 stores the information inputted in the profile part 171a of the price-related questionnaire 171 into a price-related questionnaire profile table 130a as shown in FIG. 33.

As shown in FIG. 33, the price-related questionnaire profile table 130a includes a product name column 130b, an answerer number column 130c, a name column 130d, an age column 130e and a sex column 130f.

The product name column 130b stores information for specifying the name of the product to be investigated by the price-related questionnaire 171. The information stored in this column is specified by the name of the product inputted through the registration picture 166.

The answerer number column 130c stores identification information (answerer number) for identifying the answerer. The information inputted in the answerer number column of the profile part 171a of the price-related questionnaire 171 is stored in this column.

The name column 130d stores information for specifying the name of the answerer. The information inputted in the name column of the profile part 171a of the price-related questionnaire 171 is stored in this column.

The age column 130e stores information for specifying the age of the answerer. The information inputted in the sex column of the profile part 171a of the price-related questionnaire 171 is stored in this column.

The sex column 130f stores information for specifying the sex of the answerer. The information inputted in the sex column of the profile part 171a of the price-related questionnaire 171 is stored in this column.

The price-related questionnaire profile table 130a is to be previously stored in the price-related questionnaire profile table memory area 130 of the memory 120.

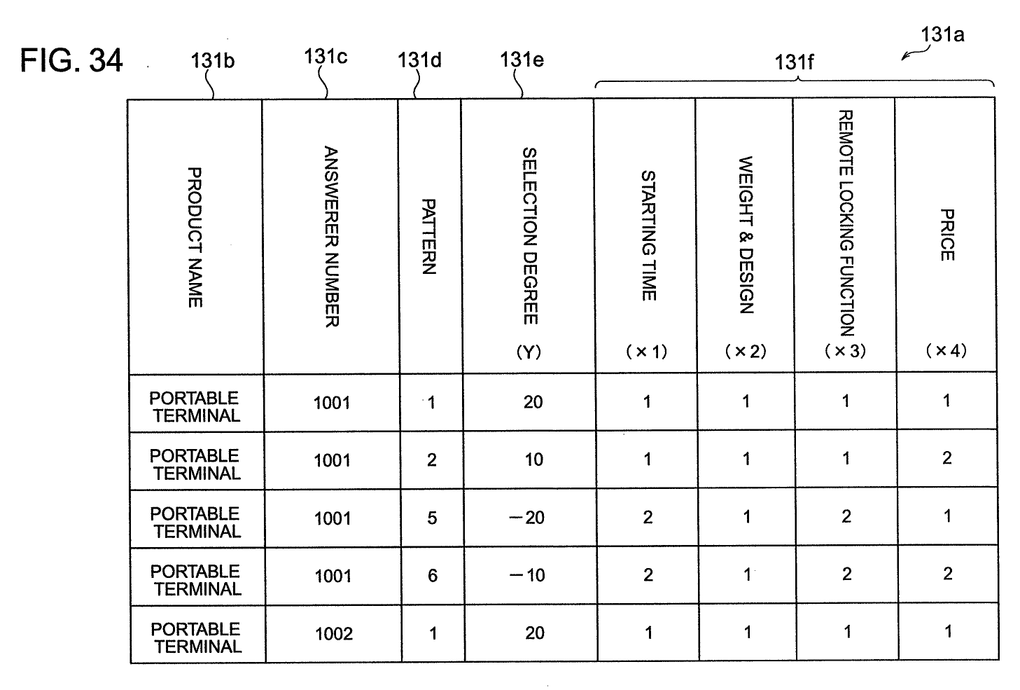

The price estimation unit 114 stores the pattern, the selection degree and the values (x1, x2, . . . , xn) of the orthogonal array of the row selected to be “desired” or “undesired” in the selection order column in the pattern selection part 171b of the price-related questionnaire 171 by the answerer into an element pattern selection table 131a as shown in FIG. 34. The numerical value corresponding to the selection order inputted by the operator of the analysis apparatus 100 is gotten from the selection degree table 168 as shown in FIG. 22 to be stored as the selection degree.

FIG. 34 shows the element pattern selection table 131a.

As shown in FIG. 34, the element pattern selection table 131a includes a product name column 131b, an answerer number column 131c, a pattern column 131d, a selection degree column 131e and an orthogonal array column 131f.

The product name column 131b stores information for specifying the name of the product to be investigated by the price-related questionnaire 171. The information stored in this column is specified by the name of the product inputted through the registration picture 166.

The answerer number column 131c stores identification information (answerer number in the embodiment) for identifying the answerer who gives an answer to the price-related questionnaire 171. As the information stored in this column, the information inputted to the answerer number column of the profile part 171a of the price-related questionnaire 171 is stored.

The pattern column 131d stores information for specifying the pattern of the values (levels) of the orthogonal array stored in the orthogonal array column 131f described later. As the information stored in this column, the information inputted to the pattern column of the pattern selection part 171b of the price-related questionnaire 171 is stored.

The selection degree column 131e stores the values of the selection degree gotten from the selection degree table 168 by the price estimation unit 114.

The orthogonal array column 131f stores the values (levels) of the orthogonal array in the pattern selection part 171b of the price-related questionnaire 171.

The price estimation unit 114 extracts the values of the selection degree and the orthogonal array from the element pattern selection table 131a and solve the regression expression as described in the expression (1) while using the selection degree as an objective variable and the values (x1, x2, . . . , xn) of the orthogonal array as explanatory variables, so that the values of the orthogonal array can be quantified.

Returning to FIG. 3, the quantities acquired above are stored in a quantity table 132a stored in the quantity table memory area 132 of the memory 120 (step S22).

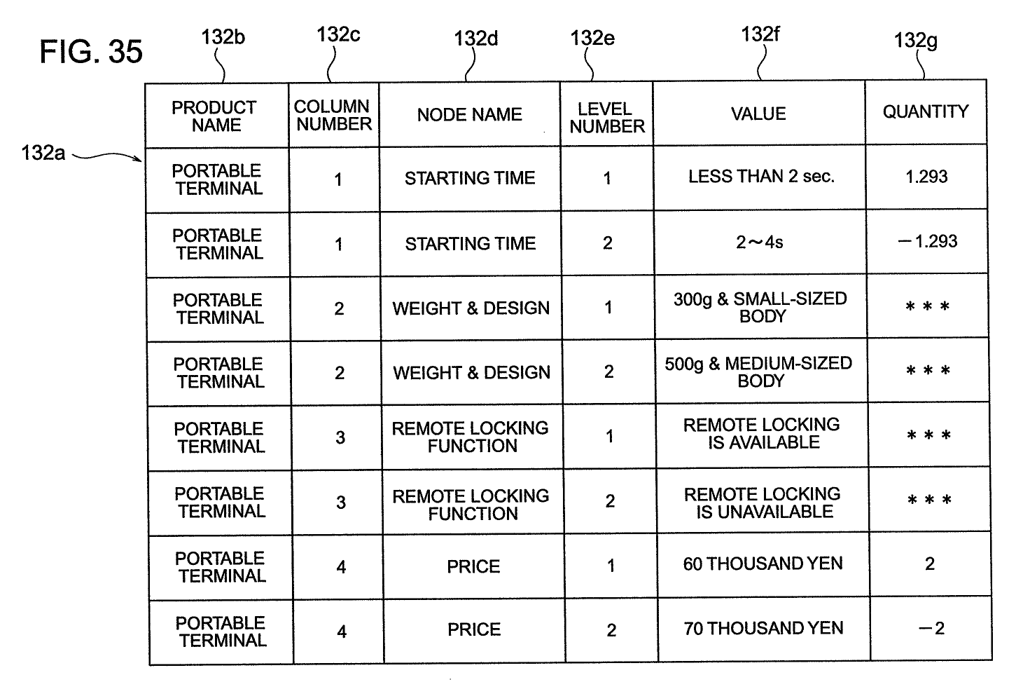

FIG. 35 shows the quantity table 132a.

As shown in FIG. 35, the quantity table 132a includes a product name column 132b, a column number column 132c, a node name column 132k, a level number column 132e, a value column 132f and a quantity column 132g.

The product name column 132b stores information for specifying the name of the product to be investigated by the price-related questionnaire 171. As the information stored in this column, the information stored in the product name column 131b of the element pattern selection table 131a is stored.

The column number column 132c stores information for specifying the column number of the orthogonal array in which the node name stored in the node name column 132d described later is stored.

The node name column 132d stores the node name stored in the column of the orthogonal array in the pattern selection part 171b of the price-related questionnaire 171.

The level number column 132e stores information for specifying the level number of the level in case where the values stored in the value column 132f described later are assigned to the orthogonal array in the pattern selection part 171b of the price-related questionnaire 171.

The value column 132f stores information for specifying the values assigned to the levels of the orthogonal array in the pattern selection part 171b of the price-related questionnaire 171.

The quantity column 132g stores information for specifying the quantity calculated by the price estimation unit 114 as described above in a corresponding manner to the information specified in the node name column 132d and the level number column 132e.

It is understood that the item having the larger quantity stored in this column is valuable specification.

Returning to FIG. 3, the target cost calculation unit 115 performs target cost calculation processing of calculating a target cost of each of elements (components) constituting the product (step S23).

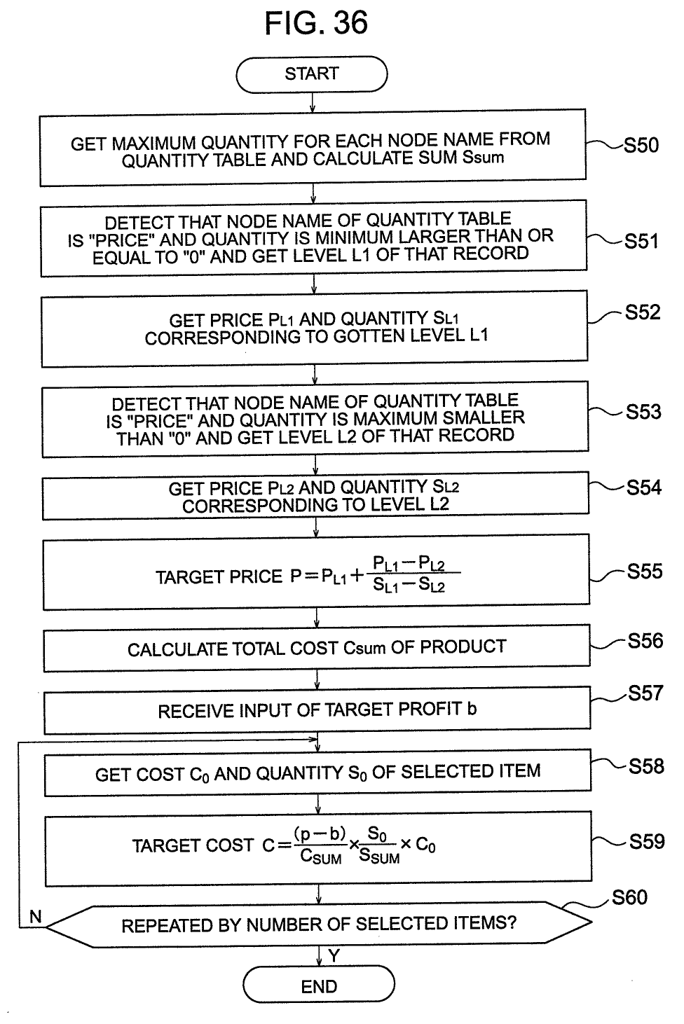

The target cost calculation processing performed by the target cost calculation unit 115 is described with reference to the flowchart shown in FIG. 36.

First, the target cost calculation unit 115 gets a maximum quantity for each node name from the node name column 132d and the quantity column 132g of the quantity table 132a and calculates a sum Ssum of the gotten quantities (step S50).

Next, the target cost calculation unit 115 gets the level number from the level number column 132e having the record in which the quantity in the quantity column 132g is positive and minimum, of the records having the price set in the node name column 132d of the quantity table 132a and defines it as level L1 (step S51).

The target cost calculation unit 115 gets the price P_{L1} and the quantity S_{L1} corresponding to the level L1 from the value column 132f and the quantity column 132g of the record corresponding to the level L1 gotten in step S51 (step S52).

The target cost calculation unit 115 gets the level number from the level number column 132e having the record in which the quantity in the quantity column 132g is smaller than “0” and maximum, of the records having the price set in the node name column 132d of the quantity table 132a and defines it as level L2 (step S53).

The target cost calculation unit 115 gets the price P_{L2} and the quantity S_{L2} corresponding to the level L2 from the value column 132f and the quantity column 132g of the record corresponding to the level L2 gotten in step S53 (step S54).

The target cost calculation unit 115 calculates the target price for each node name from the following expression (3) (step S55).

P=P_{L1}+(P_{L1}−P_{L2})/(S_{L1}−S_{L2}) (3)

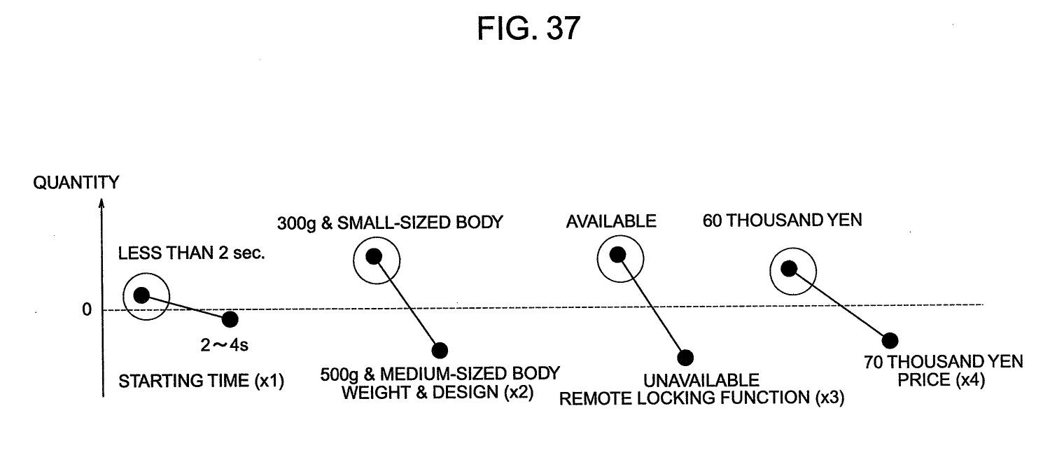

FIG. 37 shows the relation of price plans and quantity. The price in case where the quantity is “0” is to be calculated by the expression (3).

In the following steps, the target cost calculation unit 115 calculates the target cost for each element.

The target cost calculation unit 115 calculates the total cost Csum of the product (step S56).

The total cost Csum is calculated by adding the prices specified for the element nodes corresponding to the specification selected in the pattern selection part 171b of the price-related questionnaire 171 shown in FIG. 30.

The target cost calculation unit 115 receives input of target profit b from the operator of the analysis apparatus 100 by means of the input unit 140 (step S57).

The target cost calculation unit 115 gets the quantity So for each node name from the node name column 132d and the quantity column 132g of the quantity table 132a and the price p corresponding to the level of the quantity So and sets it as the cost Co (step S58).

The target cost calculation unit 115 calculates the target cost c from the following expression (4) (step S59).

c=(p−b)/cₛᵤₘ×Sₒ/Sₛᵤₘ×Sₒ (4)

The target cost calculation unit 115 calculates the target costs for all elements (step S60).

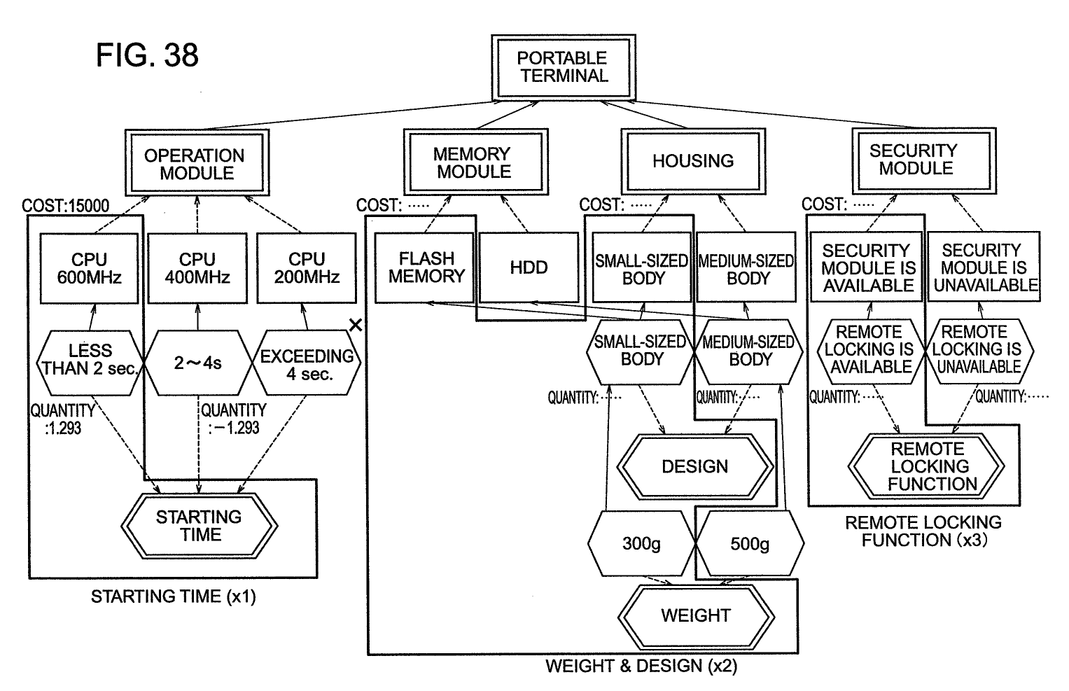

The target costs calculated as above can be displayed near the element class nodes (at left upper part in the embodiment) in the campus area 160b as shown in FIG. 38 (showing a display example of target costs), so that the selected items (costs) and the target costs can be confirmed easily.

The target costs calculated above can be used as the aim of costs of components constituting the product. Accordingly, the customers' needs for the price can be satisfied and a profit margin can be ensured.

In the embodiment described above, the needs-related questionnaire and the price-related questionnaire are displayed in the output unit 150 of the analysis apparatus 100 and necessary input information is received by means of the input unit 140 of the analysis apparatus 100, although the present invention is not limited thereto. For example, the needs-related questionnaire and the price-related questionnaire may be transmitted to a different apparatus connected to the analysis apparatus 100 through a network and be displayed in an output unit of the different apparatus to receive necessary input information through an input unit of the different apparatus.

Moreover, the needs-related questionnaire or the price-related questionnaire may be printed and necessary information written by the answerer with writing materials may be gotten, so that only the result of the gotten information may be inputted to the analysis apparatus 100.

It should be further understood by those skilled in the art that although the foregoing description has been made on embodiments of the invention, the invention is not limited thereto and various changes and modifications may be made without departing from the spirit of the invention and the scope of the appended claims.

1. An analysis apparatus comprising:
a needs relation definition unit to receive input of relation among needs for a product, worth to satisfy the needs and values of selection items for selecting the worth through an input unit; and
a needs estimation unit to prepare a questionnaire which receives selection of selection order for combination of inputted needs and selection of values for judging to be satisfactory and dissatisfactory for inputted worth and calculate strength of the needs from totalized result of the questionnaire.

2. An analysis apparatus according to claim 1, wherein
the needs estimation unit performs regression analysis about the selection order for the combination of the inputted needs in the questionnaire to calculate the strength of the needs.

3. An analysis apparatus according to claim 2, wherein
the needs estimation unit solves a regression expression in which a selection degree which is a value defined previously in a corresponding manner to a selected selection order is set as an objective variable and a level which is a value defined previously for the combination of the needs corresponding to the selected selection order is set as an explanatory variable to calculate a standardization coefficient and a significant probability, so that the strength of the needs is set to be large in order of an absolute value of the standardization coefficient having the significant probability smaller than or equal to a predetermined value.

4. An analysis apparatus according to claim 1, further comprising:
an element relation definition unit to receive input of relation among elements constituting the product, component names of selection items for selecting the elements and the worth satisfied by component specified by the component name through the input unit; and
a worth estimation unit to prepare a questionnaire which receives selection of selection order for combination of values of selection items for selecting the inputted worth and calculate height of the worth from totalized result of the questionnaire.

5. An analysis apparatus according to claim 4, wherein
the worth estimation unit performs regression analysis about the selection order for the combination of the inputted worth in the questionnaire and calculates the height of the worth.

6. An analysis apparatus according to claim 5, wherein
the worth estimation unit solves a regression expression in which a selection degree which is a value defined previously in a corresponding manner to a selected selection order is set as an objective variable and a level which is a value defined previously for the combination of the worth corresponding to the selected selection order is set as an explanatory variable to calculate a regression coefficient, so that the worth is set to be high in order of the regression coefficient.

7. An analysis apparatus according to claim 6, wherein
the worth estimation unit divides a cost of the product by a ratio of the height of the worth corresponding to the component to calculate a target cost for each component.

8. A program for making a computer function as the following:
needs relation definition means to receive input of relation among needs for a product, worth to satisfy the needs and values of selection items for selecting the worth through input means; and
needs estimation means to prepare a questionnaire which receives selection of selection order for combination of the inputted needs and selection of values for judging to be satisfactory and dissatisfactory for inputted worth and calculate strength of the needs from totalized result of the questionnaire.

9. A program according to claim 8, wherein
the needs estimation means performs regression analysis about the selection order for the combination of the inputted needs in the questionnaire to calculate the strength of the needs.

10. A program according to claim 9, wherein
the needs estimation means solves a regression expression in which a selection degree which is a value defined previously in a corresponding manner to a selected selection order is set as a objective variable and a level which is a value defined previously for the combination of the needs corresponding to the selected selection order is set as an explanatory variable to calculate a standardization coefficient and a significant probability, so that the strength of the needs is set to be large in order of an absolute value of the standardization coefficient having the significant probability smaller than or equal to a predetermined value.

11. A program according to claim 8, for further making the computer function as the following:
element relation definition means to receive input of relation among elements constituting the product, component names of selection items for selecting the elements and the worth satisfied by component specified by the component name through the input means; and
worth estimation means to prepare a questionnaire which receives selection of selection order for combination of values of selection items for selecting the inputted worth and calculate height of the worth from totalized result of the questionnaire.

12. A program according to claim 11, wherein
the worth estimation means performs regression analysis about the selection order for the combination of the inputted worth in the questionnaire and calculates the height of the worth.

13. A program according to claim 12, wherein
the worth estimation means solves a regression expression in which a selection degree which is a value defined previously in a corresponding manner to a selected selection order is set as an objective variable and a level which is a value defined previously for the combination of the worth corresponding to the selected selection order is set as an explanatory variable to calculate a regression coefficient, so that the worth is set to be high in order of the regression coefficient.

14. A program according to claim 13, wherein
the worth estimation means divides a cost of the product by a ratio of the height of the worth corresponding to the component to calculate a target cost for each component.

15. An analysis method performed by an analysis apparatus including a controller, the controller comprising:
needs relation definition process to receive input of relation among needs for a product, worth to satisfy the needs and values of selection items for selecting the worth through an input unit; and
needs estimation process to prepare a questionnaire which receives selection of selection order for combination of inputted needs and selection of values for judging to be satisfactory and dissatisfactory for inputted worth and calculate strength of the needs from totalized result of the questionnaire.
